(19) United States
(12) Patent Application Publication
(10) Pub. No.: US 2015/0301266 A1
(43) Pub. Date: Oct. 22, 2015

(54) LIGHTING DEVICE AND DISPLAY DEVICE

(71) Applicant: SHARP KABUSHIKI KAISHA, Osaka-shi, Osaka (JP)

(72) Inventors: Ryoh ARAKI, Osaka (JP); Shugo YAGI, Yonago-shi, Tottori (JP); Kazuya HATTA, Yonago-shi, Tottori (JP)

(73) Assignee: Sharp Kabushiki Kaisha, Osaka (JP)

(21) Appl. No.: 14/439,021

(22) PCT Filed: Oct. 23, 2013
(86) PCT No.: PCT/JP2013/078679

§ 371 Date: Apr. 28, 2015

(30) Foreign Application Priority Data
Oct. 30, 2012 (JP) 2012-238793

(51) Int. Cl. F21V 8/00

(52) U.S. Cl. CPC G02B 6/0055; G02B 6/0088

(57) ABSTRACT

An illumination device of the present invention is provided with: a light source; a light guide plate having a light-receiving face that faces the light source and on which light that has been generated from the light source is incident, an opposite surface that is on the opposite side to the light-receiving face, and a light-exiting surface from which light that has entered the light guide plate from the light-receiving face exits; a first wall disposed along the front-back direction of the light guide plate and having a light absorbing surface that faces the opposite surface and absorbs light that has leaked out from the light guide plate; and a first light absorbing member that extends between a front periphery adjacent to the opposite surface on the light-exiting surface and a front end of the first wall, and absorbs light that has leaked out from the light guide plate.

### TECHNICAL FIELD

The present invention relates to an illumination device and a display device.

### BACKGROUND ART

In recent years, liquid crystal panels have come into widespread use as display panels for displaying images on the display devices of electronic equipment such as portable information terminals (smartphones and tablet-type personal computers, for example). In addition to the liquid crystal panels, backlight devices (illumination devices) for supplying light to the liquid crystal panels are also being mounted in these types of display devices.

As stated in Patent Document 1, for example, an edge-lit (or a side-lit) that has been provided with a light guide plate formed from a transparent plate-shaped member, and a light source (an LED, for example) that is disposed so as to face the side face of this light guide plate, is known as the aforementioned backlight device. Light generated from the light source of the backlight device enters inside the light guide plate from the light source-facing side face of the light guide plate (light-receiving face hereinafter). Then, this light exits in the form of planar light from the front side of the plate surface (light-exiting surface hereinafter) while propagating through the inside of the light guide plate. An edge-lit backlight device like this can be made thinner than other systems (a direct-lit, for example). Thus, it is preferable that an edge-lit backlight device be used in a display device that has to be made thin, such as a portable information terminal.

As stated in Patent Document 1, in an edge-lit backlight device, when the light entering inside the light guide plate is reflected by the light guide plate side face that is on the opposite side to the light-receiving face (opposite surface hereinafter), this reflected light is known to be the cause of uneven luminance. Thus, in the backlight device disclosed in Patent Document 1, a black member for preventing reflection is provided on the opposite surface of the light guide plate to prevent the aforementioned uneven luminance.

### RELATED ART DOCUMENT

### Patent Document

Patent Document 1: Japanese Utility Model Laid-Open Publication No. H1-128285

### PROBLEMS TO BE SOLVED BY THE INVENTION

In this connection, due to increasing demand for thinner display devices in recent years, the thickness of the light guide plates used in backlight devices has also become extremely thin. Light guide plates having thicknesses of several tenths of a millimeter are also being used in the portable information terminals and the like described above, for example. Attempts have been made to provide an anti-reflection member (black tape or a black coating, for example) on the opposite surface in extremely thin light guide plates such as this to solve for uneven luminance such as that described above; however, the problem is that it is impossible to selectively provide an anti-reflection member on the opposite surface due to the extremely narrow width (the width in the thickness direction) of the opposite surface. Thus, the provision of a technique that makes it possible to suppress uneven luminance regardless of the thickness of the light guide plate (even in cases where the thickness of the light guide plate is particularly thin) is being sought.

### SUMMARY OF THE INVENTION

An object of the present invention is to provide an illumination device that suppresses uneven luminance, and a display device provided with this illumination device.

### MEANS FOR SOLVING THE PROBLEM

An illumination device according to the present invention is provided with: a light source; a light guide plate that is a plate-shaped member having a light-receiving face formed on one side face thereof that opposes the light source so as to receive light therefrom, an opposite face formed on one side face of the plate-shaped member opposite to the light-receiving face, and a light-exiting surface formed on a front surface of the plate-shaped member from which light that has entered from the light-receiving face exits; a first wall having a light absorbing surface facing the opposite face to absorb light that has leaked from the light guide plate, the first wall being disposed along a front-back direction of the light guide plate; and a first light absorbing member that extends from a front periphery of the light guide plate in the light-exiting surface adjacent to the opposite face, and that reaches a front end of the first wall so as to absorb light that has leaked from the light guide plate. In the illumination device, light that has entered from the light-receiving face of the light guide plate exits mainly from the light-exiting surface while advancing inside the light guide plate until reaching the opposite surface. Some of the light that has entered the light guide plate from the light-receiving face reaches the opposite surface, and, in addition, is leaked out to the outer side from the opposite surface. Light that has leaked out from the opposite surface is absorbed by the opposite surface-facing light absorbing surface of the first wall, and the first light absorbing member that extends between the front periphery of the light guide plate and the front end of the first wall. Therefore, the amount of light reflected by the first wall and returned once again to the inside of the light guide plate from the opposite surface is reduced. Even when the light is returned to the inside of the light guide plate once again from the opposite surface, the portion of this light that goes toward the front periphery of the light-exiting surface is absorbed by the first light absorbing member. Meanwhile, some of the light that has entered the light guide plate from the light-receiving face goes toward the light-exiting surface after having reached the opposite surface and then having been reflected by this opposite surface. The light that goes toward the front periphery of the light-exiting surface after having been reflected by the opposite surface is absorbed by the first light absorbing member. Therefore, in the illumination device, of the light that has entered the light guide plate from the light-receiving face, the light that has reached the opposite surface is absorbed by the light absorbing surface and the first light absorbing member, and thereby suppressed from exiting from the light-exiting surface. As a result of this, light being concentrated to the opposite surface side of light exiting from the light-exiting surface is suppressed, and, in turn, uneven luminance in the illumination device is suppressed.

The illumination device may further include a second light absorbing member disposed on a rear periphery of the light guide plate in a rear surface adjacent to the opposite face so as to absorb light that has leaked from the light guide plate. When a second light absorbing member is provided in the illumination device, of the light that is returned from the opposite surface to the inside of the light guide plate, the light that goes toward the rear periphery on the rear surface of the light guide plate is absorbed by the second light absorbing member. Therefore, in the illumination device, of the light that has entered the light guide plate from the light-receiving face, the light that has reached the opposite surface is further suppressed from exiting the light-exiting surface. As a result of this, the concentration of light exiting to the opposite surface side from the light-exiting surface is further suppressed, and, in turn, uneven luminance in the illumination device is further suppressed.

In the illumination device, the second light absorbing member may extend from the rear periphery of the light guide plate and reach a rear end of the first light absorbing member. In the illumination device, when the second light absorbing member extends between the rear periphery and the back end of the first wall, light that has leaked out to the outer side from the opposite surface of the light guide plate is also absorbed by the second light absorbing member. Therefore, in the illumination device, of the light that has entered the light guide plate from the light-receiving face, the light that has reached the opposite surface is further suppressed from exiting from the light-exiting surface. As a result of this, the concentration of light exiting to the opposite surface side from the light-exiting surface is further suppressed, and, in turn, uneven luminance in the illumination device is further suppressed.

In the illumination device, the first light absorbing member may have a sheet-like shape and an adhesive surface on either one side or both sides thereof. In the illumination device, when the first light absorbing member is a sheet and has an adhesive surface on either one side or both sides, the first light absorbing member can be positioned in an affixed manner by being bonded to a member in the surrounding area.

In the illumination device, the first light absorbing member may be bonded via the adhesive surface to the front periphery of the light guide plate and the front end of the first wall. In the illumination device, when the first light absorbing member is bonded via the adhesive surface to the front periphery of the light guide plate and the front end of the first wall, the first light absorbing member can easily be accurately positioned in an affixed manner to the front periphery of the light guide plate and the front end of the first wall.

In the illumination device, the first light absorbing member may be either expandable and contractible or bendable. In the illumination device, when the first light absorbing member has either elasticity or flexibility, separation of the first light absorbing member from the front periphery of the light guide plate and the front end of the first wall is suppressed because a movement of the opposite surface of the light guide plate either closer to or farther away from the first wall is tolerated, for example.

In the illumination device, the second light absorbing member may have a sheet-like shape and an adhesive surface on either one side or both sides thereof. In the illumination device, when the second light absorbing member is a sheet and has an adhesive surface on either one side or both sides, the second light absorbing member can be positioned in an affixed manner by being bonded to a member in the surrounding area.

In the illumination device, the second light absorbing member may be bonded via the adhesive surface to the rear periphery of the light guide plate and a rear end of the first wall. In the illumination device, when the second light absorbing member is bonded via the adhesive surfaces to the rear periphery of the light guide plate and the back end of the first wall, the second light absorbing member can easily be accurately positioned in an affixed manner to the rear periphery of the light guide plate and the back end of the first wall.

In the illumination device, the second light absorbing member may be either expandable and contractible or bendable. In the illumination device, when the second light absorbing member has either elasticity or flexibility, separation of the second light absorbing member from the front periphery of the light guide plate and the front end of the first wall is suppressed because a movement of the opposite surface of the light guide plate either closer to or farther away from the first wall is tolerated, for example.

The illumination device may further include: a light reflective sheet having light reflecting characteristics disposed on a rear surface of the light guide plate such that an end of the light reflective sheet protrudes beyond the opposite face of the light guide plate, and the second light absorbing member may be a coated film having light absorption characteristics formed on the light reflective sheet. In the illumination device, when a light reflective sheet having light reflection properties furnished on the rear surface of the light guide plate in a state in which an end protrudes to the outer side more than the opposite surface is provided, and the second light absorbing member is formed from a coated film having light absorption properties that has been formed on the light reflective sheet, simply arranging the light reflective sheet in a prescribed location consequently results in the second light absorbing member being arranged in the prescribed location, and the task of installing the second light absorbing member becomes easy. Furthermore, a second light absorbing member such as this is supported by the light reflective sheet, and even when the thickness is reduced, strength can be ensured more than when the second light absorbing member is prepared as a separate component. That is, the thickness of a second light absorbing member such as this can be made thinner, which is advantageous to making a thin illumination device.

In the illumination device, the first wall may be formed from a light absorbing material, and the light absorbing surface of the first wall may be a surface of the first wall facing the opposite face of the light guide plate. In the illumination device, when the first wall is formed from a light absorbing material, and the light absorbing surface is formed from the surface of the first wall that faces the opposite surface, the light absorbing surface can be easily provided.

In the illumination device, the light absorbing surface of the first wall may be a front surface of a light absorbing layer that is bonded so as to cover an opposing surface of the first wall facing the opposite face of the light guide plate, the light absorbing layer absorbing light. In the illumination device, when the light absorbing surface is bonded so as to cover a facing surface of the first wall that faces the opposite surface, and is formed from a surface of a light absorbing layer for absorbing light, a light absorbing surface can be easily provided even when a light absorbing material is unable to be used in the first wall, for example.

The illumination device may further include: a second wall having a light absorbing surface that faces a side face of the light guide plate disposed between the light-receiving surface and the opposite face to absorb light that has leaked from the light guide plate, the second wall being disposed along the front-back direction of the light guide plate; a third light absorbing member that extends from a front lateral periphery of the light guide plate in the light-exiting surface adjacent to the side face, and that reaches a front end of the second wall so as to absorb light that has leaked from the light guide plate; and a fourth light absorbing member that extends from a rear lateral periphery of the light guide plate in the rear surface adjacent to the side face, and that reaches a rear end of the second wall so as to absorb that has leaked from the light guide plate. Depending on the light source that is used, light that leaks out to the outer side from the side face of the light guide plate may be the cause of uneven luminance. In a case such as this, when the illumination device is provided with the aforementioned configuration, the concentration of light exiting to the side face side from the light-exiting surface is suppressed in accordance with the light and so forth leaking out to the outer side from the side face of the light guide plate being absorbed by the third light absorbing member and the fourth light absorbing member, and, in turn, uneven luminance in the illumination device is further suppressed.

In the illumination device, the second light absorbing member may be a coated film having light absorption characteristics formed on the rear periphery of the light guide plate. In the illumination device, when the second light absorbing member is formed from a light-absorbing coated film that has been formed on the rear periphery of the light absorbing plate, simply arranging the light guide plate in a prescribed location consequently results in the second light absorbing member being arranged in the prescribed location, and the task of installing the second light absorbing member becomes easy. Furthermore, a second light absorbing member such as this is supported by being on the rear periphery of the light guide plate, and even when the thickness is reduced, strength can be ensured more than when the second light absorbing member is prepared as a separate component. That is, the thickness of a second light absorbing member such as this can be made thinner, which is advantageous to making a thin illumination device.

A display device according to the present invention is provided with: the illumination device; and a display panel for displaying an image by using light from the illumination device.

### EFFECTS OF THE INVENTION

According to the present invention, it is possible to provide an illumination device that suppresses uneven luminance, and a display device provided with this illumination device.

### BRIEF DESCRIPTION OF THE DRAWINGS

FIG. 1 is an exploded perspective view of a liquid crystal display device according to Embodiment 1.

FIG. 2 is a plan view of a liquid crystal panel.

FIG. 3 is a plan view of a display area of an array substrate constituting a liquid crystal panel.

FIG. 4 is a plan view of a display area of a CF substrate constituting a liquid crystal panel.

FIG. 5 is a cross-sectional view taken along the line A-A′ of FIG. 1.

FIG. 6 is an enlarged view of the liquid crystal display device illustrated in FIG. 5.

FIG. 7 is a graph showing the luminance of light exiting from a light-exiting surface of a light guide plate.

FIG. 8 is a partial cross-sectional view of a liquid crystal display device according to Embodiment 2.

FIG. 9 is a partial cross-sectional view of a liquid crystal display device according to Embodiment 3.

FIG. 10 is a partial cross-sectional view of a liquid crystal display device according to Embodiment 4.

FIG. 11 is a partial cross-sectional view of a liquid crystal display device according to Embodiment 5.

FIG. 12 is a partial cross-sectional view of a liquid crystal display device according to Embodiment 6.

FIG. 13 is a cross-sectional view of a liquid crystal display device according to Embodiment 7.

FIG. 14 is a partial cross-sectional view of a liquid crystal display device according to Reference Example 1.

FIG. 15 is a partial cross-sectional view of a liquid crystal display device according to Reference Example 2.

### DETAILED DESCRIPTION OF EMBODIMENTS

### Embodiment 1

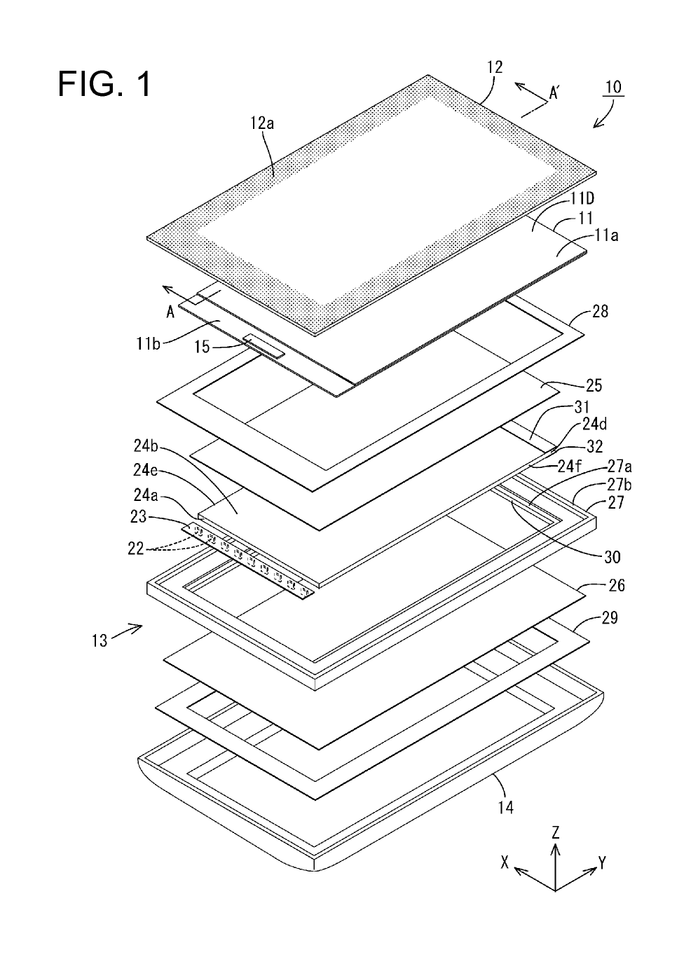

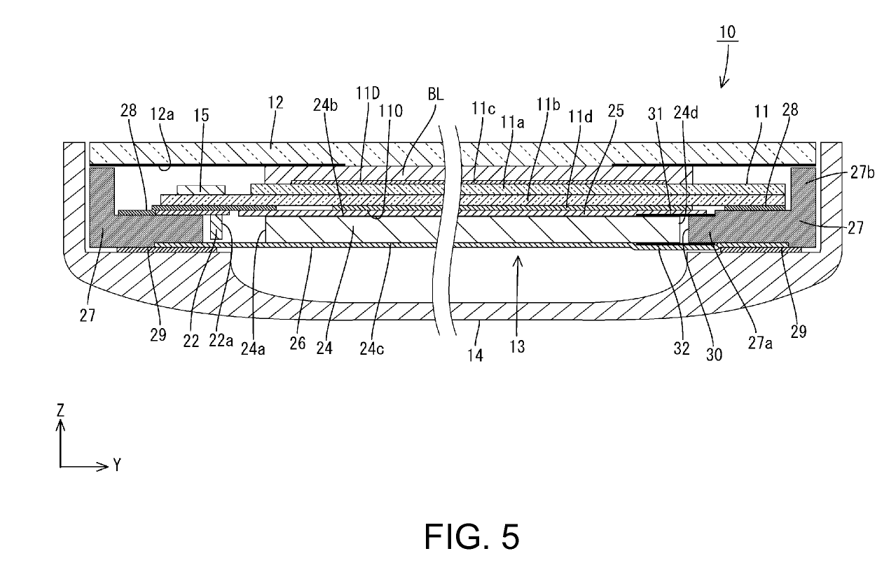

Embodiment 1 of the present invention will be described while referring to FIGS. 1 to 7. The present embodiment illustrates an example of a liquid crystal display device (display device) provided with a backlight device (illumination device). Mutually intersecting X, Y and Z axes are shown in each drawing. FIG. 5 is the criteria for the vertical direction. The upper side of this drawing is the front side, and the lower side of this drawing is the back side.

FIG. 1 is an exploded perspective view of a liquid crystal display device 10 according to Embodiment 1. As shown in FIG. 1, the overall the liquid crystal display device 10 forms a longitudinal rectangular shape. The liquid crystal display device 10 is provided with: a liquid crystal panel (display panel) 11 in which a front surface is a display surface 11D for displaying an image, and a rear surface is an opposite surface 11O; a cover panel 12 disposed so as to face the display surface 11D of the liquid crystal panel 11; and a backlight device (illumination device) 13 that is disposed (on the opposite side to the cover panel 12 side) so as to face the opposite surface 11O of the liquid crystal panel 11 and supplies light to the liquid crystal panel 11. In addition, the liquid crystal display device 10 is provided with a casing (case member, outer packaging member) 14 for housing the cover panel 12, the liquid crystal panel 11, and the backlight device 13. Of the components of the liquid crystal display device 10, the cover panel 12 and the casing 14 constitute the external appearance of the liquid crystal display device 10. The liquid crystal display device 10 according to the present embodiment is used in various types of electronic equipment, such as portable information terminals (cell phones, smartphones, and tablet-type personal computers, for example), on-board information terminals (stationary-type car navigation systems and portable car navigation systems, for example), and portable game machines. Thus, the screen size of the liquid crystal panel 11 and cover panel 12 constituting the liquid crystal display device 10 is from around several inches and more than 10 inches, and is generally a size classified as either small or small to medium.

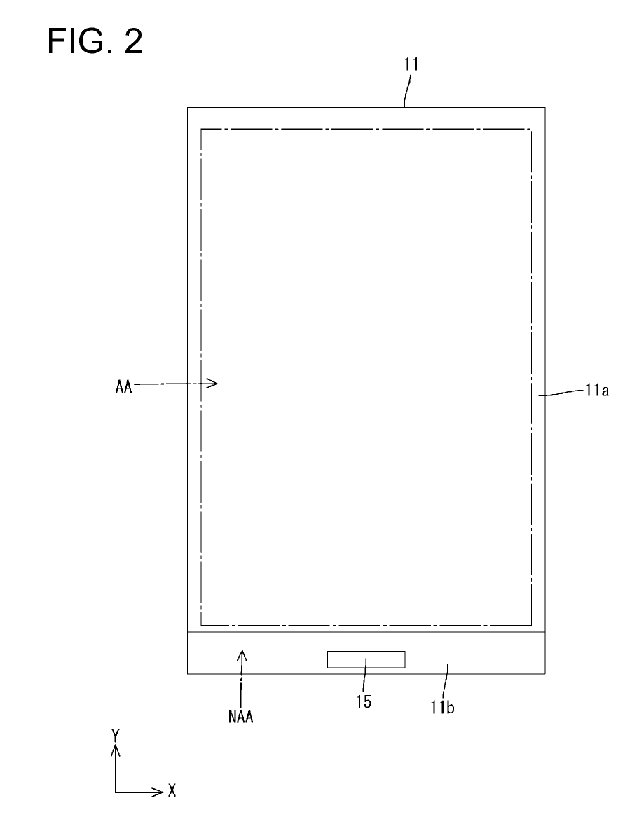

FIG. 2 is a plan view of the liquid crystal panel 11. As shown in FIG. 2, overall the liquid crystal panel 11 forms a longitudinal rectangular shape. A display area (active area) AA for displaying an image is disposed in a position that is slightly offset toward the one end side (top side shown in FIG. 2) in the longer-side direction of the liquid crystal panel 11. Then, a driver (panel driver) 15 for driving the liquid crystal panel 11 is mounted in an offset position on the other end side (bottom side shown in FIG. 2) in the longer-side direction of the liquid crystal panel 11. In the liquid crystal panel 11, a region that forms an approximate frame shape (picture frame shape) encircling the display area AA is a non-display area (non-active area) NAA, which does not display an image, and the aforementioned driver 15 is mounted here in a direct chip on glass (COG) manner. A flexible substrate (not shown in the drawing) for supplying various types of input signals to the driver 15 is connected to the non-display area NAA of this liquid crystal panel 11. The longer side direction of the liquid crystal panel 11 coincides with the Y-axis direction, and the shorter side direction coincides with the X-axis direction. Furthermore, the frame-shaped one-dot chain line shown in FIG. 2 represents an outline of the display area AA, and a region on the outer side of this one-dot chain line forms the non-display area NAA.

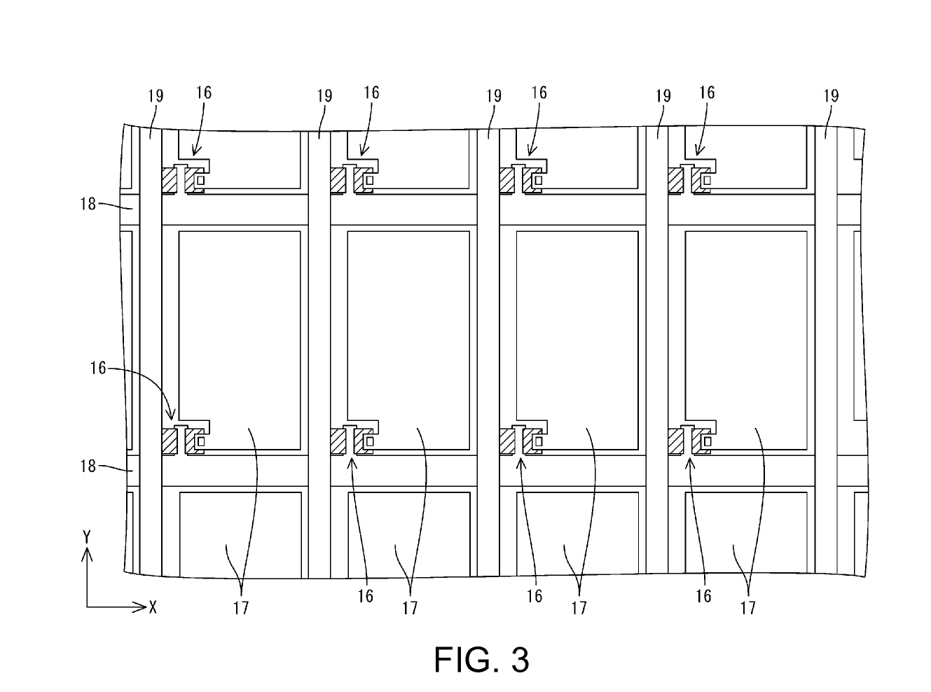

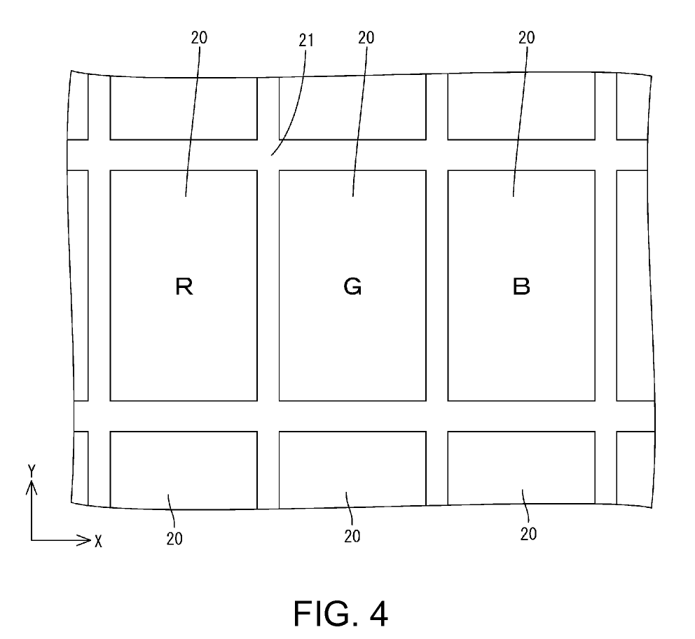

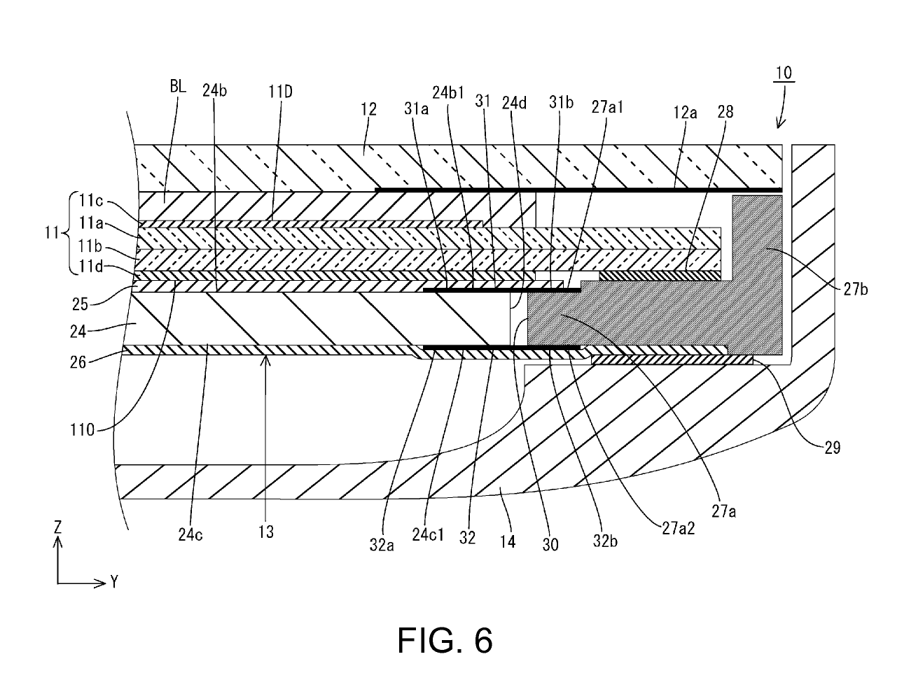

FIG. 3 is a plan view of the display area AA of an array substrate 11b constituting the liquid crystal panel 11, FIG. 4 is a plan view of the display area AA of a CF substrate constituting the liquid crystal panel 11, FIG. 5 is a cross-sectional view along the line A-A′ of FIG. 1, and FIG. 6 is an enlarged view of the liquid crystal display device 10 shown in FIG. 5. The liquid crystal panel 11, as shown in FIG. 5, is provided with a pair of transparent (having translucence) glass substrates 11a and 11b, and a liquid crystal layer (not shown in the drawings) that includes liquid crystal molecules, which is matter, interposed between the two substrates 11a and 11b and having optical characteristics that change in accordance with the application of an electric field, and the two substrates 11a and 11b are bonded using a sealant, which is not shown in the drawings, so as to maintain a gap proportional to the thickness of the liquid crystal layer. The plate thickness of each of the pair of substrates 11a and 11b is around 0.2 mm, for example, and this makes the liquid crystal panel 11 thinner. Of these, as shown in FIG. 2, the shorter-side dimensions of the CF substrate 11a are roughly the same as those of the array substrate 11b, but the longer-side dimensions are smaller than those of the array substrate 11b, and the CF substrate 11a is bonded to the array substrate 11b such that one end (top side in FIG. 2) has been aligned in the longer-side direction. Therefore, both the front and back plate surfaces of the other end (bottom side of FIG. 2) of the array substrate 11b in the longer-side direction are exposed on the outer side without the CF substrate 11a overlapping across a prescribed range, and the driver 15 mounting area and so forth are reserved here. Polarizing plates 11c and 11d are respectively bonded to the outer surface sides of both of the substrates 11a and 11b, and the size (area) of the two polarizing plates 11c and 11d is slightly larger than the display area AA.

Of the pair of substrates 11a and 11b that constitute the liquid crystal panel 11, the front side (front surface side) is the CF substrate 11a, and the back side (rear surface side) is the array substrate 11b. Large numbers of thin film transistors (TFT) 16, which are switching elements, and pixel electrodes 17 are lined up matrix-like on the inner surface side of the array substrate 11b (liquid crystal layer side, opposite surface side of the CF substrate 11a) as shown in FIG. 3, and large numbers of gate wires 18 and source wires 19, which form a grid pattern, are arranged in an encircling manner around these TFTs 16 and pixel electrodes 17. In other words, the TFTs 16 and pixel electrodes 17 are parallelly arranged in matrices at the intersections of the gate wires 18 and source wires 19, large numbers of each of which are parallelly arranged so as to form a grid pattern. Although the gate wires 18 and the source wires 19 are formed from metal films having both conductivity and light-shielding properties (thin films of copper, aluminum, titanium and other such metal materials, for example), short-circuits are prevented from occurring at the intersections by disposing these wires 18 and 19 in mutually different layers and interposing not-shown insulating films therebetween. The gate wires 18 and source wires 19 are respectively connected to TFT 16 gate electrodes and source electrodes, and the pixel electrodes 17 are connected to TFT 16 drain electrodes. Whereas the gate electrode of the TFT 16 is formed from the same metal film and is disposed in the same layer as the gate wire 18, the source electrode and drain electrode of the TFT 16 are formed from the same metal film and disposed in the same layer as the source wire 19. The ends of these gate wires 18 and source wires 19 are connected to the driver 15, and receive signals from the driver 15. The pixel electrode 17 is formed from a transparent electrode film having conductivity and transparency (thin film of a transparent conductive material, such as indium tin oxide (ITO), for example).

Alternatively, as shown in FIG. 4, a large number of color filters (CF) is provided side by side on the inner surface side of the CF substrate 11a (liquid crystal layer side, opposite surface side of the array substrate 11b) in locations that overlap in the plan view with the respective pixel electrodes 17 on the array substrate 11b side. The color filters are arranged such that the colored portions 20, which take on R (red), G (green), and B (blue), are lined up side by side in an alternating manner along the X-axis direction. A colored portion 20 forms a rectangular shape in the plan view, the longer-side direction and the shorter-side direction thereof coinciding with the longer-side direction and the shorter-side direction of the substrates 11a and 11b, and large numbers thereof are parallelly arranged in matrices in the X-axis direction and the Y-axis direction of the CF substrate 11a. A black matrix 21 that forms a grid pattern for preventing color mixing is formed between the respective colored portions 20 constituting the color filters. The black matrix 21 is arranged overlapping in the plan view the gate wires 18 and the source wires 19 of the array substrate 11b. In the liquid crystal panel 11, a single pixel, which is a unit of display, is formed using a set of the three colored portions 20 R, G, B and three corresponding pixel electrodes 17, and the pixels are arranged side by side in large numbers in matrices along the plate surfaces (X-axis direction and Y-axis direction) of both substrates 11a and 11b. Not-shown facing electrodes (common electrodes) that face the pixel electrodes 17 of the array substrate 11b are provided on the surfaces of the respective colored portions 20 and black matrix 21. Alignment films (not shown in the drawings) for aligning the liquid crystal molecules included in the liquid crystal layer are respectively formed on the inner surface sides of both substrates 11a and 11b.

As shown in FIGS. 1 and 5, the cover panel 12 is disposed so as to completely cover the liquid crystal panel 11 from the front side, and can thus protect the liquid crystal panel 11. The liquid crystal panel 11 is bonded via an adhesive BL to the rear surface of a center side part of the cover panel 12 (specifically, the part that overlaps in the plan view with the entire display area AA of the liquid crystal panel 11 and the non-display area NAA inner peripheral side portion adjacent to the display area AA). This adhesive BL is applied in a liquid state to either one or both of the liquid crystal panel 11 and the cover panel 12, and can join the two panels 11 and 12 together in a bonded state by being cured after the two panels 11 and 12 have been bonded. Since the interposing of air spaces between the cover panel 12 and the liquid crystal panel 11 is avoided, display quality is improved. It is preferable that an ultraviolet-curable resin material, which is cured by irradiating an ultraviolet light, be used as the adhesive BL. The cover panel 12 is formed from plate-shaped tempered glass having high transparency, for example.

The cover panel 12 forms a longitudinal rectangular shape in a manner similar to the liquid crystal panel 12. The size of the cover panel 12 in the plan view is set one size larger than the substrates 11a and 11b that form the liquid crystal panel 11. The outline of the cover panel 12 is practically the same as that of a panel support frame 27, which will be described below. Therefore, the outer peripheral side portion of the cover panel 12 protrudes visor-like to the outer side from the outer peripheral edge of the liquid crystal panel 11. A light-shielding part 12a, which is disposed so as to encircle the display area AA of the liquid crystal panel 11 and overlap in the plan view with the non-display area NAA, and which blocks light around the periphery of the display area AA, is formed on the cover panel 12. The light-shielding part 12a is formed from a light-shielding material, such as a coating material that takes on a black color, for example, and this light-shielding material is provided in an integrated manner by printing on the rear surface of the cover panel 12, that is, on the plate surface of the liquid panel 11 side. When providing the light-shielding part 12a, a printing technique, such as screen printing or inkjet printing, for example, can be used. In addition to the portion of the cover panel 12 that completely overlaps the non-display area NAA on the liquid crystal panel 11, the light-shielding part 12a is formed in a longitudinal approximate frame shape (approximate picture frame shape) in the plan view by being formed on an outer peripheral side portion of the cover panel 12 that protrudes more toward the outer side than the outer peripheral edge of the liquid crystal panel 11, and this enables light to be blocked by the light-shielding part 12a at a stage prior to the light from the backlight device 13 becoming incident on the rear surface of the cover panel 12 surrounding the display area AA. That is, the light-shielding part 12a is formed over practically the entire region of the part of the cover panel 12 that does not overlap in the plan view with the display area AA of the liquid crystal panel 11. In FIG. 1, the light-shielding part 12a is shown as a half-tone dot mesh, and a white rectangular area on the inner side thereof is the area through which the light of the display area AA is transmitted.

The backlight device (illumination device) 13, as shown in FIGS. 1 and 5, forms a longitudinal rectangular shape overall in the plan view in a manner similar to the liquid crystal panel 11. The backlight device 13 is provided with: a light emitting diode (LED) 22, which is the light source; an LED substrate (light source substrate) 23 on which the LED 22 is mounted; a light guide plate 24 for guiding the light from the LED 22; an optical sheet (optical member) 25, which is arranged in a laminated manner on the light guide plate 24; a light reflective sheet 26, which is arranged in a laminated manner on the light guide plate 24; a panel support frame (panel support member) 27, which encircles the light guide plate 24 and the optical sheet 25 and supports the liquid crystal panel 11 from the back side (the opposite side to the cover panel 12 side); a first light absorbing member 31, and a second light absorbing member 32. This backlight device 13 is a so-called edge-lit backlight device, which is disposed so that the LED 22 is eccentrically located at the end of the outer peripheral side of the liquid crystal panel 11. The components of the backlight device 13 will be described in a sequential manner below.

As shown in FIG. 5, the LED (light source) 22 includes an LED chip, which is sealed using a resin material onto a substrate part that is firmly fixed to the plate surface of the LED substrate 23. A substrate part-mounted LED chip that has a single main light emitting wavelength, specifically, an LED chip that emits blue as a single color is used. Meanwhile, a prescribed color-emitting fluorescent material, which is excited by the blue light emitted from the LED chip, is mixed in a dispersed manner into the resin material for sealing the LED chip, and overall emits a generally white color light. This LED 22 is what is called a side emission type, in which a side adjacent to the mounting surface on the LED substrate 23 is a light-emitting surface 22a.

As shown in FIGS. 1 and 5, the LED substrate 23 has a flexible film (sheet) base material, which is made of an insulating material, the LED 22 is surface mounted onto this base material, and a wiring pattern for supplying electricity to the LED 22 is patterned thereon. The LED substrate 23 is disposed on only one end of the shorter-side side of the backlight device 13, and extends along the shorter-side direction (Y-axis direction) of the backlight device 13. A plurality of LEDs 22 is mounted on the LED substrate 23 so as to line up side by side with gaps therebetween along this extending direction. The LED substrate 23 is disposed so as to be sandwiched between the liquid crystal panel 11 and the below-described panel support frame 27 in the thickness direction (Z-axis direction) of the backlight device 13. Therefore, the mounting surface of the LEDs 22 on the LED substrate 23 is the surface facing toward the back side (the opposite side to the liquid crystal panel 11).

The light guide plate 24, as shown in FIGS. 1 and 5, is a longitudinal plate-shaped member arranged in a parallel manner relative to the plate surface of the liquid crystal panel 11. The light guide plate 24 is formed from a transparent synthetic resin or the like, such as an acrylic resin or a polycarbonate. Of four outer peripheral side faces of the light guide plate 24, a side face 24a of a shorter-side side shown on the left side of FIG. 5 faces the LEDs 22, and is a light-receiving face 24a. That is, light emitted from the LEDs 22 is irradiated onto this side face 24a, and then the light enters inside the light guide plate 24 from this side face 24a. In the case of the present embodiment, the light-receiving face 24a is provided on only one of the four outer peripheral side faces. The other shorter-side side face 24d, which is on the opposite side to the light-receiving face 24a, faces the inner peripheral side part (inner wall 27a) of the panel support frame 27, which will be described below, and in the present Specification, the side face 24d is called the opposite surface 24d. Of the two side faces of the longer-side sides of the light guide plate 24, the one on the far side in the drawing of FIG. 1 is side face 24e, and the one on the near side in the drawing of FIG. 1 is side face 24f.

The front side (liquid crystal panel 11 side) plate surface 24b of the light guide plate 24 is a light-exiting surface 24b from which light exits toward the liquid crystal panel 11. Light, which has spread out in a planar manner, exits from the light-exiting surface 24b toward the liquid crystal panel 11. The light guide plate 24 rear surface 24c, which is on the opposite side to the light-exiting surface 24b, is covered by a light reflective sheet 26, which will be described below. A fine dot-shaped reflection/diffusion pattern (not shown in the drawing), which causes light that has entered inside the light guide plate 24 to be either reflected or diffused, is formed on the rear surface 24c of the light guide plate 24. As will be described below, within the plate surface (light-exiting surface) 24b on the front side of the light guide plate 24, a portion adjacent to the opposite surface 24d is where one end of a first light absorbing member 31 is bonded. Furthermore, within the plate surface 24c on the back side of the light guide plate 24, a portion adjacent to the opposite surface 24d is where one end of a second light absorbing member 32 is bonded.

The optical sheet 25, as shown in FIGS. 1 and 5, is disposed by being placed on top of the light-exiting surface 24b of the light guide plate 24 and interposed between the liquid crystal panel 11 and the light guide plate 24, thereby transmitting the outgoing light from the light guide plate 24, and causing this transmitted light to go toward the liquid crystal panel 11 while imparting a prescribed optical effect thereto. The shape of the optical sheet 25 is a longitudinal rectangle in the same manner as the light guide plate 24, and the size (longer-side dimensions and shorter-side dimensions), in the plan view, is larger than the light guide plate 24 but smaller than the array substrate 11b of the liquid crystal panel 11. The optical sheet 25 is formed from a so-called lens sheet, and the lens part (not shown in the drawing) provided on the lens sheet faces toward the bottom side (that is, the light guide plate 24 side), and is disposed so as to cover the light-exiting surface 24b. On the bottom surface of the lens sheet, a plurality of lens parts, which is formed from protrusions that are triangular in cross-section, is provided lined up side by side to one another in a parallel manner. In another embodiment, a plurality of sheets may be used in a laminated state. Well-known optical sheets, such as a diffusion sheet and a reflective polarizing sheet, for example, can be cited as other optical sheets.

As shown in FIGS. 1 and 5, the light reflective sheet 26 is disposed so as to cover the rear (opposite side to the light-exiting surface 24b) plate surface 24c of the light guide plate 24. The light reflective sheet 26 is formed from a sheet material having a surface with outstanding light reflectivity. The light reflective sheet 26 reflects light propagating inside the light guide plate 24 toward the front side (light-exiting surface 24b). The shape of the light reflective sheet 26 is a longitudinal rectangle in the same manner as the light guide plate 24, and the size (longer-side dimensions and shorter-side dimensions), in the plan view, is larger than the light guide plate 24 and about the same or larger than the array substrate 11b of the liquid crystal panel 11. The light reflective sheet 26 overlaps practically the entire liquid crystal panel 11 (display area AA and non-display area NAA) in the plan view, and also overlaps, in the plan view, the inner peripheral side part (inner wall 27a) of the panel support frame 27, which will be described next. The second light absorbing member 32 is formed so as to be sandwiched between the light reflective sheet 26 and the rear surface 24c of the light guide plate 24, and between the light reflective sheet 26 and the inner peripheral side part (inner wall 27a) of the panel support frame 27, respectively.

The panel support frame 27 overall forms a longitudinal rectangular frame shape, and the outline thereof, in the plan view, is set to substantially the same as the outer diameter of the cover panel 12. The panel support frame 27 houses the light guide plate 24 and the optical sheet 25 so as to be supported by the portion on the inner peripheral edge side thereof. The panel support frame 27 is formed from a pair of shorter-side portions, which extend in the direction of the X axis, and a pair of longer-side portions, which extend in the direction of the Y axis, and these shorter-side portions and longer-side portions are connected to one another in an intersecting manner. The panel support frame 27 faces the rear surfaces (including the opposite surface 11O) of the outer peripheral end of the cover panel 12 formed by the light-shielding part 12a and the outer peripheral end (one part) of the non-display area NAA of the liquid crystal panel 11, and can support these plate surfaces along the entire periphery from the back side. The panel support frame 27 supports a major portion of the outer peripheral end of the optical sheet 25 from the back side. The panel support frame 27 is molded from a plastic material (one example of a light absorbing material) having light absorbency. The panel support frame 27 is formed from a plastic material into which a black coloring agent has been mixed, and the outer surface thereof is black.

The panel support frame 27, as shown in FIGS. 5 and 6, is provided with a frame-shaped inner wall (first wall) 27a disposed on an inner side, and an outer wall 27b disposed on the outer side of the inner wall 27a and protruding toward the front side more than the inner wall 27a. A side face of the front side of the outer wall 27b is the portion that supports the outer peripheral end of the cover panel 12 from the back side. An outer side portion of a side face of the front side of the inner wall 27a is the portion that supports the outer peripheral end of the liquid crystal panel 11 from the back side via a panel adhesive tape 28. The liquid crystal panel 11 and the panel support frame 27 are affixed to one another using the panel adhesive tape 28. The panel adhesive tape 28 has a flexible tape-shaped base material, and an adhesive is applied on both the front and back sides of this base material. The panel adhesive tape 28 is formed into a longitudinal approximate frame shape in accordance the shape of the panel support frame 27, which is the adhesion target (FIG. 1). The liquid crystal panel 11 and the panel support frame 27 are affixed along practically the entire periphery by the panel adhesive tape 28.

Then, the inner side portion of the side face of the front side of the inner wall 27a is one level lower than the outer side portion. This lowered portion is the portion that supports the outer peripheral end of the optical sheet 25 from the back side. As will be described below, the one-level-lower side face of the front side of the inner wall 27a is where the other end of the first light absorbing member 31 is bonded. A location, which has been lowered one level as described above, is not formed on the inner side portion of the front side of the inner wall 27a on the LED 22 side of the panel support frame 27. The LED substrate 23 is placed on top of the side face of the front side of the inner wall 27a on the LED 22 side (refer to FIG. 5). The LED substrate 23 is inserted between the inner wall 27a of the panel support frame 27 and the end of the array substrate 11b of the liquid crystal panel 11.

The inner wall 27a forms a planar shape where a portion facing the opposite surface 24d of the light guide plate 24 is disposed along the thickness direction (front-back direction, Z-axis direction) of the light guide plate 24, and this portion is a light absorbing surface 30 that absorbs light. Light that has leaked out from the opposite surface 24d and so forth of the light guide plate 24 is absorbed by the light absorbing surface 30. The light absorbing surface 30 is formed by the inner peripheral surface of the inner wall 27a, and forms an elongated shape that extends along the shorter-side direction of the light guide plate 24. That is, the light absorbing surface 30 of the present embodiment forms an elongated rectangular shape (belt shape, long continuous shape). The width (length) in the direction of the Z axis (front-back direction, shorter-side direction) of such a light absorbing surface 30 is set to substantially the same as the thickness of the light guide plate 24. Furthermore, the width (length) in the direction of the X axis (longer-side direction) of the light absorbing surface 30 is set to somewhat longer than the length of the light guide plate 24 in the shorter-side direction. The light absorbing surface 30 is provided on the inner peripheral surface of the inner wall 27a facing at least the opposite surface 24d of the light guide plate 24. The light absorbing surface 30 of the present embodiment is formed from the inner peripheral surface of the inner wall 27a itself, which is formed from a light absorbing material, and is black in color. The light absorption coefficient of the light absorbing surface 30 is appropriately set at a range capable of achieving the object of the present invention.

The first light absorbing member 31 is a member for absorbing light that has leaked out from the opposite surface 24d and so forth of the light guide plate, and is provided in the backlight device 13 so as to extend between the front periphery 24b1 adjacent to the opposite surface 24d on the front surface (light-exiting surface) 24b of the light guide plate 24 and the front end 27a1 of the inner wall (first wall) 27a. The first light absorbing member 31 includes a black-colored resin base material and so forth for absorbing light. The first light absorbing member 31 of the present embodiment is a small-thickness (thin) sheet, and an adhesive is applied to both surfaces (front and back surfaces) of an elastically deformable black-colored resin base material having either elasticity or flexibility. Thus, both sides of the first light absorbing member 31 of the present embodiment function as adhesive surfaces that are capable of joining (adhering) to respective other members.

The first light absorbing member 31 of the present embodiment, in plan view, forms an elongated rectangle extending along the shorter-side direction (X-axis direction) of the light guide plate 24. The width (length) in the longer-side direction (X-axis direction) of the first light absorbing member 31 is substantially the same as the length in the shorter-side direction (X-axis direction) of the light guide plate 24. One end 31a in the shorter-side direction (Y-axis direction) of the first light absorbing member 31 is bonded to the light-exiting surface 24b of the light guide plate 24 so that the back surface thereof adheres closely to the front periphery 24b1. The other end 31b in the shorter-side direction (Y-axis direction) of the first light absorbing member 31 is bonded to the inner wall (first wall) 27a so that the back surface thereof adheres closely to the front end 27a1. The surface (front side) of the first light absorbing member 31 is bonded to the back surface of the optical sheet 25.

The second light absorbing member 32 is a member for absorbing at least light that leaks out to the outer side from the rear periphery 24c1 adjacent to the opposite surface 24d on the rear surface 24c of the light guide plate 24. In the case of the present embodiment, the second light absorbing member 32 is a member for absorbing light that has leaked out from the opposite surface 24d of the light guide plate 24 in addition thereto. The second light absorbing member 32 is provided in the backlight device 13 so as to extend between the rear periphery 24c1 and the back end 27a2 of the inner wall (first wall). The second light absorbing member 32 includes a black-colored resin base material and so forth that absorbs light in a manner similar to the first light absorbing member 31. The second light absorbing member 32, in a manner similar to the first light absorbing member 31, is a small-thickness (thin) sheet, and an adhesive is applied to both surfaces (front and back surfaces) of an elastically deformable black-colored resin base material having either elasticity or flexibility. Thus, both surfaces of the second light absorbing member 32 of the present embodiment function as adhesion surfaces that are capable of joining (adhering) to respective other members.

The second light absorbing member 32 of the present embodiment, in the plan view, forms an elongated rectangular shape extending along the shorter-side direction (X-axis direction) of the light guide plate 24. The width (length) in the longer-side direction (X-axis direction) of the second light absorbing member 32 is substantially the same as the length in the shorter-side direction (X-axis direction) of the light guide plate 24. That is, the second light absorbing member 32 is substantially the same external shape as the first light absorbing member 31. One end 32a in the shorter-side direction (Y-axis direction) of the second light absorbing member 32 is bonded to the rear surface 24c of the light guide plate 24 so that the back surface thereof adheres closely to (is furnished on) the rear periphery 24c1. The other end 32b in the shorter-side direction (Y-axis direction) of the second light absorbing member 32 is bonded to the inner wall (first wall) 27a so that the back surface thereof adheres closely to the back end 27a2. The back surface of the second light absorbing member 32 is bonded to the front surface (front side) of the light reflective sheet 26.

The casing 14 is formed from either a synthetic resin material or a metal material, and as shown in FIGS. 1, 5 and so forth, is an approximate bowl (substantially bowl shaped) with an opening toward the front side. The cover panel 12, liquid crystal panel 11, and backlight device 13 are housed within a housing space formed on the inner side of the casing 14. The casing 14 covers the backlight device 13 from the back side, and constitutes the external appearance of the back side and lateral side of the liquid crystal display device 10 by covering the entire circumference of the backlight device 13 and the cover panel 12 from the side. In the casing 14, a casing adhesive tape 29 for bonding the part of the backlight device 13 that faces the panel support frame 27 to the back side surface of the panel support frame 27 is arranged so as to be interposed therebetween, and the casing 14 and the panel support frame 27 are maintained in a mounted state by this panel adhesive tape 28. Since the casing adhesive tape 29 is formed in a longitudinal approximate frame shape overall in accordance with the shape of the panel support frame 27, which is the adhesion target, the casing 14 and the panel support frame 27 are affixed along practically the entire periphery. One part of the casing adhesive tape 29 is also bonded to the outer peripheral end of the light reflective sheet 26. The casing adhesive tape 29 has a flexible tape-like base material, and adhesive is applied to both the front and back surfaces of this base material; the casing adhesive tape 29 thus has the same material properties as the panel adhesive tape 28 described above. Substrates and the like, which are not shown in the drawings, such as a control substrate for controlling the driving of the liquid crystal panel 11 and/or an LED driver substrate for supplying drive power to the LEDs 22, are housed in a remaining space on the back side of the backlight device 13 within the housing space of the casing 14.

In a liquid crystal display device 10 provided with a configuration like that described above, when driving the LEDs (light sources) 22, light is emitted from the light-emitting surfaces 22a thereof, and this light enters into the light guide plate 24 from the light-receiving face 24a. The light that has entered advances through the inside of the light guide plate 24 toward the side of the opposite surface 24d while repeatedly being reflected between the front surface 24b and the rear surface 24c. Most of the light that has entered inside the light guide plate 24 from the light-receiving face 24a exits from the light-exiting surface 24b before reaching the opposite surface 24d. However, some of this light, after having reached the opposite surface 24d, leaks out towards the outer side (the inner wall 27a of the panel support frame 27, the first light absorbing member 31, and so forth) from the opposite surface 24d. This leaked light is absorbed by the light absorbing surface 30 of the inner wall 27a, the first light absorbing member 31, and the second light absorbing member 32. There is also light that is returned to the inside of the light guide plate 24 once again from the opposite surface 24d without being absorbed, and a portion of this light that goes toward the front periphery 24b1 of the light-exiting surface 24b is absorbed by the end 31a of the first light absorbing member 31. Some of the light that is returned to the inside of the light guide plate 24 goes toward the rear periphery 24c1 of the rear surface 24c and is absorbed by the end 32a of the second light absorbing member 32. Furthermore, some of the light that has advanced through the inside of the light guide plate 24 and reached the opposite surface 24d is also reflected by the opposite surface 24d and goes toward the front surface (light-exiting surface) 24b and/or the rear surface 24c. Of this light, a portion that goes toward the front periphery 24b1 is absorbed by the end 31a of the first light absorbing member 31, and a portion that goes toward the rear periphery 24c1 is absorbed by the end 32a of the second light absorbing member 32.

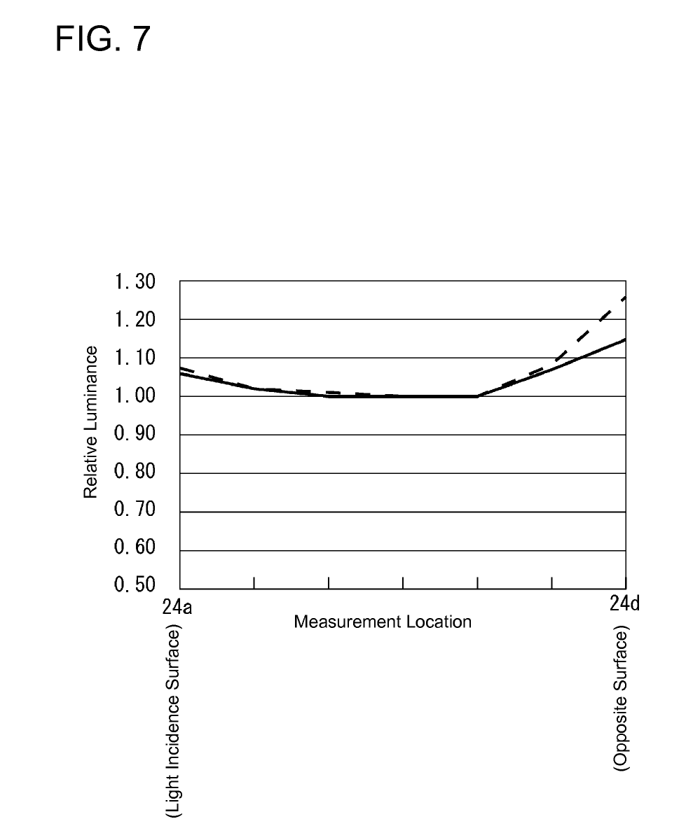

A luminance of the light that exits from the light-exiting surface 24b of the light guide plate 24 will be described here while referring to FIG. 7. FIG. 7 is a graph showing the luminance of the light that exits from the light-exiting surface 24b of the light guide plate 24. The horizontal axis of the graph in FIG. 7 represents luminance measurement locations, and the vertical axis represents the luminance (relative luminance). The luminance measurement locations shown on the horizontal axis of FIG. 7 are provided at seven locations in the shorter-side direction (Y-axis direction, LED 22 optical axis direction) of the light guide plate 24 so as to divide the space between the light-receiving face 24a and the opposite surface 24d into six equal parts. Of these measurement locations, the luminance at the middle measurement location is set to a reference value (1.00), and the luminance at the other measurement locations is set to a relative value (relative luminance). In FIG. 7, the graph shown using a solid line represents the relative luminance of light that exits from the light-exiting surface 24b of the light guide plate 24 in the liquid crystal display device 10 (backlight device 13) provided with the first light absorbing member 31 and the second light absorbing member 32. Furthermore, in FIG. 7, the graph shown using a dashed line represents the relative luminance of light that exits from the light-exiting surface 24b of the light guide plate 24 in a comparison example, which, in place of the panel support frame 27, used a (low light absorbency) panel support frame (not shown in the drawings) that excludes the first light absorbing member 31 and the second light absorbing member 32 from the liquid crystal display device 10 (backlight device 13) of the present embodiment, is not the same shape as the panel support frame 27, and is not provided with as much light absorbency as the panel support frame 27.

As shown in FIG. 7, in the liquid crystal display device 10 (backlight device 13) of the present embodiment provided with the first light absorbing member 31 and the second light absorbing member 32, it is clear that the light exiting from the light-exiting surface 24b of the light guide plate 24 is more uniform than the light of the comparison example. It is clear that light exiting from the end region (including the front periphery 24b1) of the opposite surface 24d side of the light-exiting surface 24b is lowered by providing the light absorbing surface 30, the first light absorbing member 31, and the second light absorbing member 32. In the light-exiting surface 24b, the front periphery 24b1 adjacent to the opposite surface 24d is a portion, which, when viewed in plan view, is covered in a concealed manner by the non-display area NAA of the liquid crystal panel 11. Hypothetically, in a case where the first light absorbing member 31 is not provided on the front periphery 24b1 as in the comparison example, light that has exited from the front periphery 24b1, after passing through the optical sheet 25 and the liquid crystal panel 11, goes toward the frame-shaped light-shielding part 12a side provided on the rear periphery of the cover panel 12. When a large amount of light has exited from the front periphery 24b1, after having been reflected and the like by the light-shielding part 12a and so forth, light from the inner side (inner peripheral edge side) of the frame-shaped light-shielding part 12a ultimately leaks out to the front side, and this leaked light becomes the cause of display unevenness (uneven luminance) in the liquid crystal display device (comparison example). However, when the light absorbing surface 30, the first light absorbing member 31, and the second light absorbing member 32 are provided in the liquid crystal display device 10 as in the present embodiment, light exiting from the front periphery 24b1 of the light-exiting surface 24b is reduced, and therefore the generation of display unevenness (uneven luminance) in the liquid crystal display device 10 (backlight device 13) is suppressed as a result. Furthermore, in the plate surface 24c on the back side of the light guide plate 24, the rear periphery 24c1 adjacent to the opposite surface 24d is a portion, which, when viewed in the plan view, is covered in a concealed manner by the non-display area NAA of the liquid crystal panel 11. In the case of the present embodiment, the rear periphery 24c1 is substantially the same size as the front periphery 24b1 in the plan view.

In a case where a lens sheet disposed so that the lens part faces the bottom side (the side of the light guide plate 24) is used as the optical sheet 25 as in the present embodiment, the luminance of light exiting from the end region (including the front periphery 24b1) of the opposite surface 24d side of the light-exiting surface 24b in particular becomes relatively high (refer to the comparison example of FIG. 7). Thus, it is preferable that the amount of light exiting from the end region (including the front periphery 24b1) of the opposite surface 24d side of the light-exiting surface 24b be reduced using the light absorbing surface 30, the first light absorbing member 31, and the second light absorbing member 32 as in the present embodiment.

As described above, the backlight device (illumination device) 13 according to the present invention is provided with: LEDs (light sources) 22; a light guide plate 24, which is a plate-shaped member having a light-receiving face 24a formed from one side face of the plate-shaped member that faces the LEDs 22 and on which light generated by the LEDs 22 is incident, an opposite surface 24d formed from one side face of the plate-shaped member that is on a side opposite to the light-receiving face 24a, and a light-exiting surface 24b formed from the front surface of the plate-shaped member and from which light that has entered from the light-receiving face exits; an inner wall (first wall) 27a disposed along the front-back direction of the light guide plate 24 and having a light absorbing surface 30 that faces the opposite surface 24d and absorbs light that has leaked out from the light guide plate 24; and a first light absorbing member 31 that extends between a front periphery 24b1 adjacent to the opposite surface 24d on the light-exiting surface 24b and a front end 27a1 of the inner wall (first wall) 27a, and absorbs light that has leaked out from the light guide plate 24.

In the backlight device 13 of the present embodiment, light that has entered from the light-receiving face 24a of the light guide plate 24 advances through the inside of the light guide plate 24 and exits mainly from the light-exiting surface 24b before reaching the opposite surface 24d. Some of the light that has entered the light guide plate 24 from the light-receiving face 24a reaches the opposite surface 24d, and, in addition, leaks out to the outer side from the opposite surface 24d. Light that has leaked out from the opposite surface 24d is absorbed by the opposite surface 24d-facing light absorbing surface 30 of the inner wall (first wall) 27a, and the first light absorbing member 31 that extends between the front periphery 24b1 of the light guide plate 24 and the front end 27a1 of the inner wall (first wall) 27a. Therefore, the amount of light, which is reflected by the inner wall (first wall) 27a and so forth and is returned once again to the inside of the light guide plate 24 from the opposite surface 24d, is reduced. Even when the light is returned to the inside of the light guide plate 24 once again from the opposite surface 24d, the portion of this light that goes toward the front periphery 24b1 of the light-exiting surface 24b is absorbed by the first light absorbing member 31. Meanwhile, some of the light that has entered the light guide plate 24 from the light-receiving face 24a reaches the opposite surface 24d and goes toward the light-exiting surface 24b after having been reflected by the opposite surface 24d. The light that goes toward the front periphery 24b1 of the light-exiting surface 24b after having been reflected by the opposite surface 24d is absorbed by the first light absorbing member 31. Therefore, in the backlight device 13 of the present embodiment, of the light that has entered the light guide plate 24 from the light-receiving face 24a, the light that has reached the opposite surface 24d is suppressed from exiting from the light-exiting surface 24b by being absorbed by the light absorbing surface 30 and the first light absorbing member 31. As a result of this, the concentration of light to the opposite surface 24d side of the light exiting from the light-exiting surface 24b is suppressed, and, in turn, uneven luminance is suppressed in the backlight device 13.

Furthermore, the backlight device 13 of the present embodiment is provided with the second light absorbing member 32 furnished on the rear periphery 24c1 adjacent to the opposite surface 24d on the rear surface 24c of the light guide plate 24, and absorbs light that has leaked out from the light guide plate 24. When the backlight device 13 is provided with the second light absorbing member 32, some of the light that has been returned from the opposite surface 24d to the inside of the light guide plate 24 goes toward the rear periphery 24c1 on the rear surface 24c of the light guide plate 24 and is absorbed by the second light absorbing member 32. Therefore, in the backlight device 13 of the present embodiment, of the light that has entered the light guide plate 24 from the light-receiving face 24a, the light that has reached the opposite surface 24d is further suppressed from exiting from the light-exiting surface 24b. As a result of this, the concentration of light to the opposite surface 24d side of the light exiting from the light-exiting surface 24b is further suppressed, and, in turn, uneven luminance is further suppressed in the backlight device 13.

In the backlight device 13 of the present embodiment, the second light absorbing member 32 extends between the rear periphery 24c1 and the back end 27a2 of the inner wall (first wall) 27a. In the backlight device 13, when the second light absorbing member 32 extends between the rear periphery 24c1 and the back end 27a2 of the inner wall (first wall) 27a, light that has leaked out to the outer side from the opposite surface 24d of the light guide plate 24 is also absorbed by the second light absorbing member 32. Therefore, in the backlight device 13, of the light that has entered the light guide plate 24 from the light-receiving face 24a, the light that has reached the opposite surface 24d is further suppressed from exiting from the light-exiting surface 24b. As a result of this, the concentration of light to the opposite surface 24d side of the light exiting the light-exiting surface 24b is further suppressed, and, in turn, uneven luminance is further suppressed in the backlight device 13.

In the backlight device 13 of the present embodiment, the first light absorbing member 31 is a sheet and has an adhesive surface on both sides. In the backlight device 13, when the first light absorbing member 31 is a sheet and has an adhesive surface on both sides, the first light absorbing member 31 can be positioned in an affixed manner by being bonded to a member in the surrounding area. Furthermore, in the backlight device 13 of the present embodiment, the first light absorbing member 31 is bonded via the adhesive surfaces to the front periphery 24b1 of the light guide plate 24 and the front end 27a1 of the inner wall (first wall) 27a. In the case of the present embodiment, the front side adhesive surface of the first light absorbing member 31 is positioned in an affixed manner so as to be bonded to the optical sheet 25. The back side adhesive surface of the first light absorbing member 31 is positioned in an affixed manner so as to be bonded to both the front periphery 24b1 of the light guide plate 24 and the front end 27a1 of the inner wall (first wall) 27a. In the backlight device 13 of the present embodiment, when the first light absorbing member 31 is bonded via the adhesive surfaces to the front periphery 24b1 of the light guide plate 24 and the front end 27a1 of the inner wall (first wall) 27a, the first light absorbing member 31 can easily be accurately positioned in an affixed manner to the front periphery 24b1 of the light guide plate 24 and the front end 27a1 of the inner wall (first wall) 27a.

In the backlight device 13 of the present embodiment, the first light absorbing member 31 has either elasticity or flexibility. Therefore, even when the opposite surface 24d of the light guide plate 24 moves closer to the inner wall (first wall) 27a in accordance with the light guide plate 24 expanding with heat, this movement is tolerated by the first light absorbing member 31 stretching, for example. Furthermore, even when the light guide plate 24 is cooled and contracts, and the opposite surface 24d of the light guide plate 24 moves closer to the inner wall (first wall) 27a, this movement is tolerated by the first light absorbing member 31 contracting or warping. Therefore, separation of the first light absorbing member 31 from the front periphery 24b1 of the light guide plate 24 and the front end 27a1 of the inner wall (first wall) 27a is suppressed.

In the backlight device 13 of the present embodiment, the second light absorbing member 32 is a sheet and has an adhesive surface on both sides. Therefore, the second light absorbing member 32 can be positioned in an affixed manner so as to bond to a member in the surrounding area. In the backlight device 13 of the present embodiment, the second light absorbing member 32 is bonded via the adhesive surfaces to the rear periphery 24c1 of the light guide plate 24 and the back end 27a2 of the inner wall (first wall) 27a. Therefore, the second light absorbing member 32 can easily be accurately positioned in an affixed manner to the rear periphery 24c1 of the light guide plate 24 and the back end 27a2 of the inner wall (first wall) 27a.

In the backlight device 13 of the present embodiment, the second light absorbing member 32 has either elasticity or flexibility. Therefore, even when the opposite surface 24d of the light guide plate 24 moves closer to the inner wall (first wall) 27a in accordance with the light guide plate 24 expanding with heat, this movement is tolerated by the second light absorbing member 32 stretching, for example. Furthermore, even when the light guide plate 24 is cooled and contracts, and the opposite surface 24d of the light guide plate 24 moves closer to the inner wall (first wall) 27a, this movement is tolerated by the second light absorbing member 32 contracting or warping. Therefore, separation of the second light absorbing member 32 from the rear periphery 24c1 of the light guide plate 24 and the back end 27a2 of the inner wall (first wall) 27a is suppressed.

In the backlight device 13 of the present embodiment, the inner wall (first wall) 27a is formed from a light absorbing material, and the light absorbing surface 30 is formed from the surface of the inner wall (first wall) 27a that faces the opposite surface 24d. Therefore, the light absorbing surface 30 can be easily provided.

### Embodiment 2

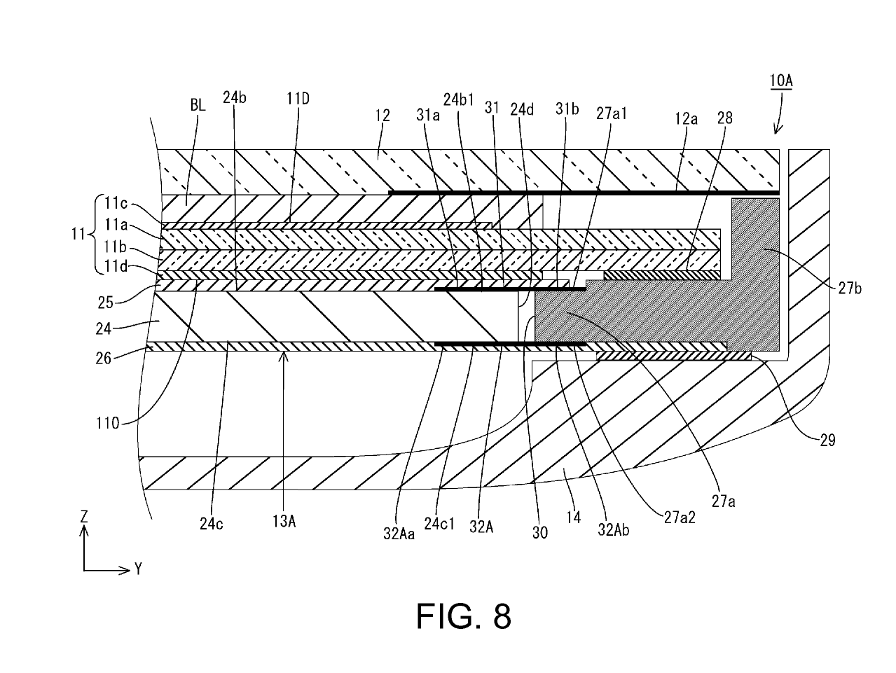

Next, Embodiment 2 of the present invention will be described while referring to FIG. 8. FIG. 8 is a partial cross-sectional view of a liquid crystal display device 10A according to Embodiment 2. In the embodiments that follow, the same reference characters as Embodiment 1 are given to parts that are the same as Embodiment 1, and detailed descriptions (configurations, effect, and so forth) will be omitted. The present embodiment illustrates a liquid crystal display device 10A provided with a backlight device 13A. The basic configuration of the liquid crystal display device 10A of the present embodiment is the same as that of Embodiment 1. However, a second light absorbing member 32A of the liquid crystal display device 10A of the present embodiment differs from that of Embodiment 1. Specifically, the second light absorbing member 32A of the present embodiment is formed from a light absorbing coated film that is formed on a light reflective sheet 26.

The second light absorbing member 32A is formed from a black-colored coated film (coating material) that absorbs light. The black-colored coated film is prepared by mixing a black coloring agent into a base resin, for example. An end of the light reflective sheet 26, as shown in FIG. 8, protrudes to the outer side from an opposite surface 24d of a light guide plate 24 in a similar manner to Embodiment 1, and this protruding part of the light reflective sheet 26 is furnished on the back side of a panel support frame 27 (mainly the inner wall 27a). The front side (front surface) of the light reflective sheet 26 is furnished on a rear periphery 24c1, which is on the back side of the light guide plate 24, and is furnished on a back end 27a2 of an inner wall (first wall) 27a. The second light absorbing member 32A is provided at least in a portion of the front side of the light reflective sheet 26 that is furnished on the rear periphery 24c1. More preferentially, the second light absorbing member 32A is provided in a portion that has been inserted between the portion furnished on the rear periphery 24c1 and a light absorbing surface 30 of the inner wall (first wall) 27a. In the case of the present embodiment, the second light absorbing member 32A is also provided in a portion that makes contact with the back end 27a2 of the inner wall (first wall) 27a. In the case of the present embodiment, an adhesive surface is not formed on the front side of the second light absorbing member 32A. The second light absorbing member 32A is formed, as appropriate, using a known printing technique and coating device. In another embodiment, a so-called one-sided seal-like second light absorbing member that has been provided with an adhesive surface on the back side may be used by being bonded to the light reflective sheet 26.

As described above, the backlight device 13A of the present embodiment is provided with a light-reflecting light reflective sheet 26 furnished on the rear surface 24c of the light guide plate 24 so that an end protrudes toward the outer side more than the opposite surface 24d, and the second light absorbing member 32A is formed from a light absorbing coated film formed on the light reflective sheet 26. Therefore, simply arranging the light reflective sheet 26 in a prescribed location consequently results in the second light absorbing member 32A being arranged in the prescribed location (the rear periphery 24c1 of the light guide plate 24 and so forth), and the task of installing the second light absorbing member 32A becomes easy. Furthermore, this second light absorbing member 32A is supported by the light reflective sheet 26, and even when thickness is reduced, is stronger than when the second light absorbing member is prepared as a separate component. That is, the thickness of this second light absorbing member 32A can be made thinner, which is advantageous to making the backlight device 13A thinner.

### Embodiment 3

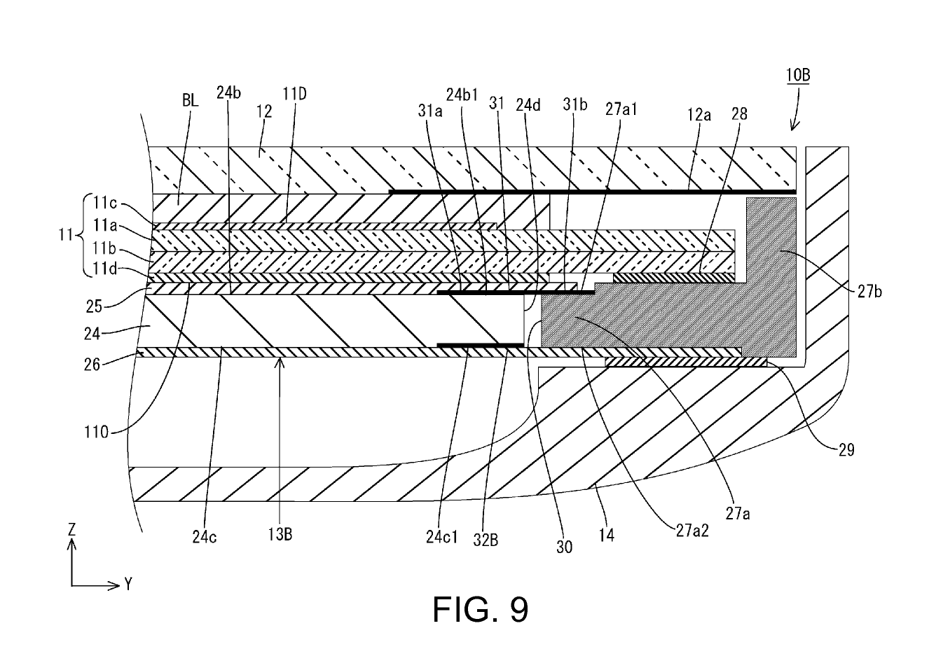

Embodiment 3 of the present invention will be described next while referring to FIG. 9. FIG. 9 is a partial cross-sectional view of a liquid crystal display device 10B according to Embodiment 3. The present embodiment illustrates a liquid crystal display device 10B provided with a backlight device 13B. The basic configuration of the liquid crystal display device 10B of the present embodiment is the same as that of Embodiment 1. However, a second light absorbing member 32B of the liquid crystal display device 10B of the present embodiment differs from that of Embodiment 1. Specifically, the second light absorbing member 32B of the present embodiment is formed directly on a rear periphery 24c1 on a rear surface 24c of a light guide plate 24.

The second light absorbing member 32B is formed from a black-colored coated film (coating material) that absorbs light. The black-colored coated film is prepared by mixing a black coloring agent into a base resin, for example. Furthermore, the rear periphery 24c1 has a larger area than the opposite surface 24d of the light guide plate 24, which makes it easy to form the coated film.

As described above, the second light absorbing member 32B of the backlight device 13B of the present embodiment is formed from a light absorbing coated film that has been formed on the rear periphery 24c1 of the light guide plate 24. Therefore, the second light absorbing member 32B is consequently arranged in a prescribed location by simply arranging the light guide plate 24 in the prescribed location, and the task of installing the second light absorbing member 32B becomes easy. Furthermore, this second light absorbing member 32B is supported on the rear periphery 24c1 of the light guide plate 24, and even when the thickness is reduced, is stronger than when the second light absorbing member is prepared as a separate component. That is, the thickness of this second light absorbing member 32B can be made thinner, which is advantageous to making the backlight device 13B thinner.

In a case where it is not necessary to provide a second light absorbing member between the opposite surface 24d of the light guide plate 24 and the light absorbing surface 30, it is preferable that the second light absorbing member 32B be provided directly on the light guide plate 24 as in the backlight device 13B of the present embodiment.

### Embodiment 4

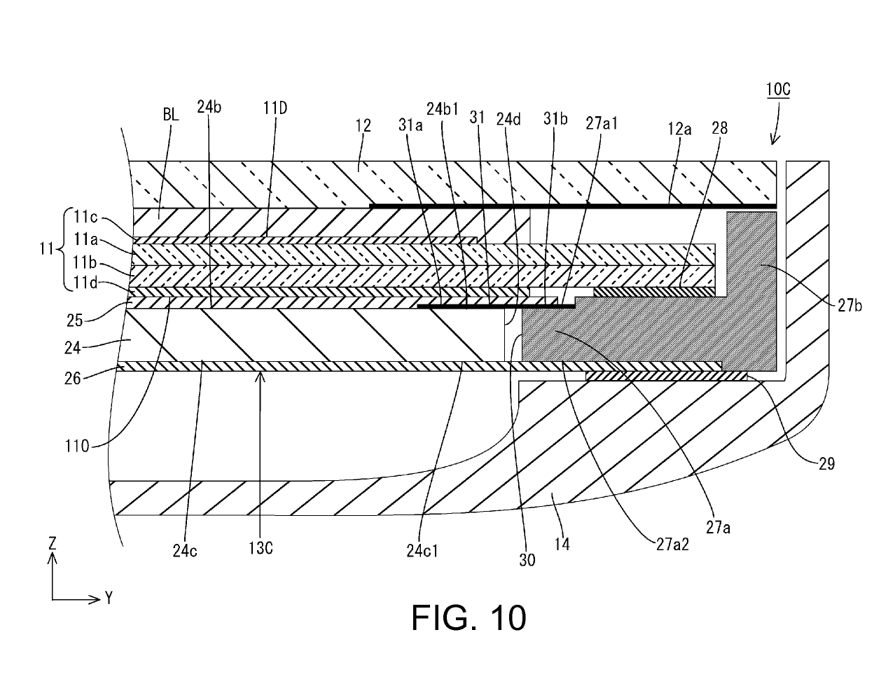

Embodiment 4 of the present invention will be described next while referring to FIG. 10. FIG. 10 is a partial cross-sectional view of a liquid crystal display device 10C according to Embodiment 4. The present embodiment illustrates a liquid crystal display device 10C provided with a backlight device 13C. The liquid crystal display device 10C of the present embodiment has a configuration that excludes the second light absorbing member 32 from the liquid crystal display device 10 (backlight device 13) of Embodiment 1.

Therefore, in the backlight device 13C of the present embodiment, of the light that has entered the light guide plate 24 from the light-receiving face 24a, light that has reached the opposite surface 24d is suppressed from exiting from the light-exiting surface 24b by being absorbed by the light absorbing surface 30 and the first light absorbing member 31. As a result of this, the concentration of light to the opposite surface 24d side of the light exiting from the light-exiting surface 24b is suppressed, and, in turn, uneven luminance is suppressed in the illumination device.

Thus, in a case where the amount of light leaking out from the opposite surface 24d and so forth of the light guide plate 24 is smaller than in Embodiment 1 (when there is less light from the LEDs 22), the light absorbing surface 30 and the first light absorbing member 31 alone may be used as in the present embodiment.

### Embodiment 5

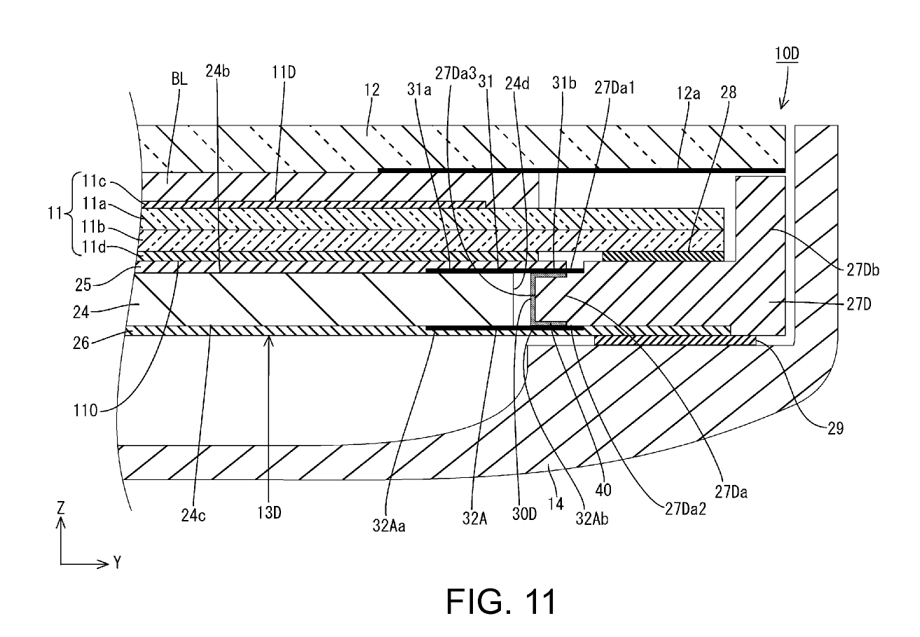

Embodiment 5 of the present invention will be described next by referring to FIG. 11. FIG. 11 is a partial cross-sectional view of a liquid crystal display device 10D according to Embodiment 5. The present embodiment illustrates a liquid crystal display device 10D provided with a backlight device 13D. The basic configuration of the liquid crystal display device 10D of the present embodiment is the same as that of Embodiment 1. However, the liquid crystal display device 10D of the present embodiment differs from Embodiment 1 in that a panel support frame 27D is formed from a metal (an aluminum-based material, for example). The external shape of the panel support frame 27D is the same as that of Embodiment 1. Specifically, an inner wall 27Da of the panel support frame 27D of the present embodiment corresponds to the inner wall 27a of Embodiment 1, and an outer wall 27Db of the panel support frame 27D corresponds to the outer wall 27b of Embodiment 1.

In this connection, a portion of the inner wall 27Da of the panel support frame 27D that faces the opposite surface 24d of the light guide plate 24 (facing surface 27Da3 hereinafter) is glossy, and is provided with light reflectivity. Therefore, a light absorbing layer 40 that absorbs light is provided in the inner wall 27Da facing surface 27Da3 that faces the opposite surface 24d, and the front surface (surface facing the opposite surface 24d) of the light absorbing layer 40 constitutes a light absorbing surface 30D for absorbing light that has leaked out from the opposite surface 24d of the light guide plate 24. The light absorbing layer 40 is formed by applying an adhesive to one side of a black-colored sheet (film) made of a light absorbing material, for example. The light absorbing layer 40 needs to be formed at least on the portion of the inner wall 27Da that faces the opposite surface 24d, but in the case of the present embodiment, to make it easier to provide the light absorbing layer 40 in a narrow space, the light absorbing layer 40 is formed from a front end 27Da1 to a back end 27Da2 so as to cover the portion (surface) facing the opposite surface 24d. The second light absorbing member 32A of the present embodiment has the same configuration as that of Embodiment 2.

As described above, the light absorbing surface 30D of the backlight device 13D of the present embodiment is formed from the front surface of the light absorbing layer 40 for absorbing light, and is bonded so as to cover the inner wall (first wall) 27Da facing surface 27Da3 that faces the opposite surface 24d. Therefore, the light absorbing surface 30D can be easily provided even in a case where a metal material is used as the inner wall (first wall) 27Da (that is, when a light absorbing material cannot be used).

### Embodiment 6

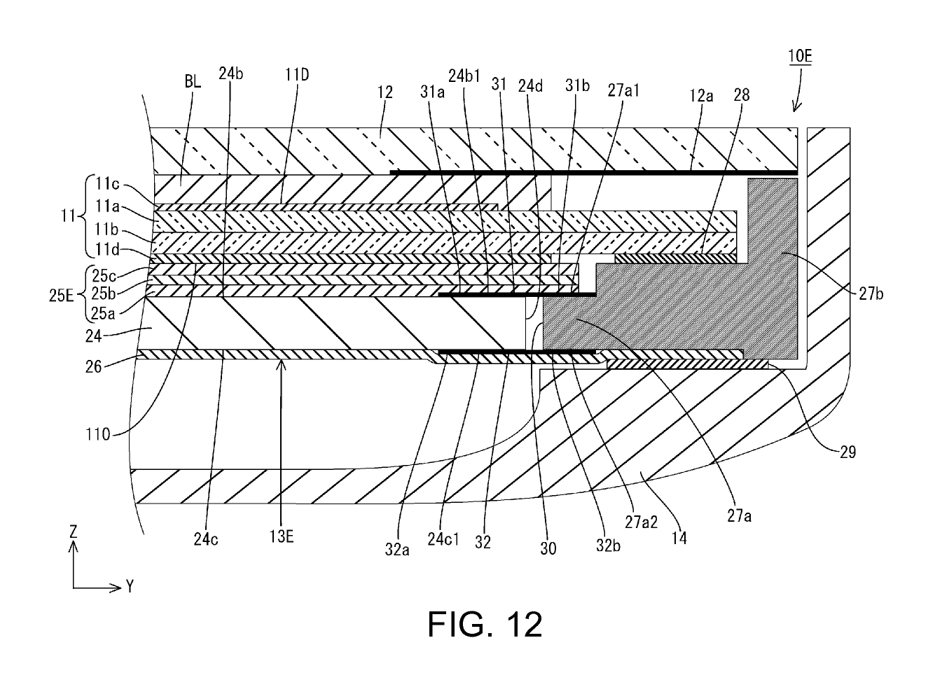

Next, Embodiment 6 of the present invention will be described while referring to FIG. 12. FIG. 12 is a partial cross-sectional view of a liquid crystal display device 10E according to Embodiment 6. The present embodiment illustrates a liquid crystal display device 10E provided with a backlight device 13E. The basic configuration of the liquid crystal display device 10E of the present embodiment is the same as that of Embodiment 1. However, an optical sheet 25E of the liquid crystal display device 10E of the present embodiment differs from that of Embodiment 1. In the present embodiment, an optical sheet 25E formed from a laminate of three optical sheets is used in place of the optical sheet 25 of Embodiment 1.

The optical sheet 25E is formed by laminating a diffusion sheet 25a, a lens sheet 25b, and a reflective polarizing sheet 25c, in that order, from the bottom side (back side) to the top side. The lens sheet 25b differs from the lens sheet used in Embodiment 1, and is disposed so that the lens part, which is formed from protrusions that are triangular in cross-section, faces toward the top side (that is, the liquid crystal panel 11 side) and covers the light-exiting surface 24b of the light guide plate 24. The lens sheet 25b having a lens part that faces toward the top side as in the present embodiment may be used as an optical sheet. Thus, even when the lens sheet 25b having a lens part that faces toward the top side has been used, light and so forth that reaches the opposite surface 24d of the light guide plate 24 and thereafter leaks out to the outer side from the opposite surface 24d can be absorbed using the light absorbing surface 30, the first light absorbing member 31, and the second light absorbing member 32. In so doing, in the backlight device 13D of the present embodiment, the concentration of light to the opposite surface 24d side of light exiting from the light-exiting surface 24b is suppressed, and, in turn, uneven luminance is suppressed in the backlight device 13D.

### Embodiment 7

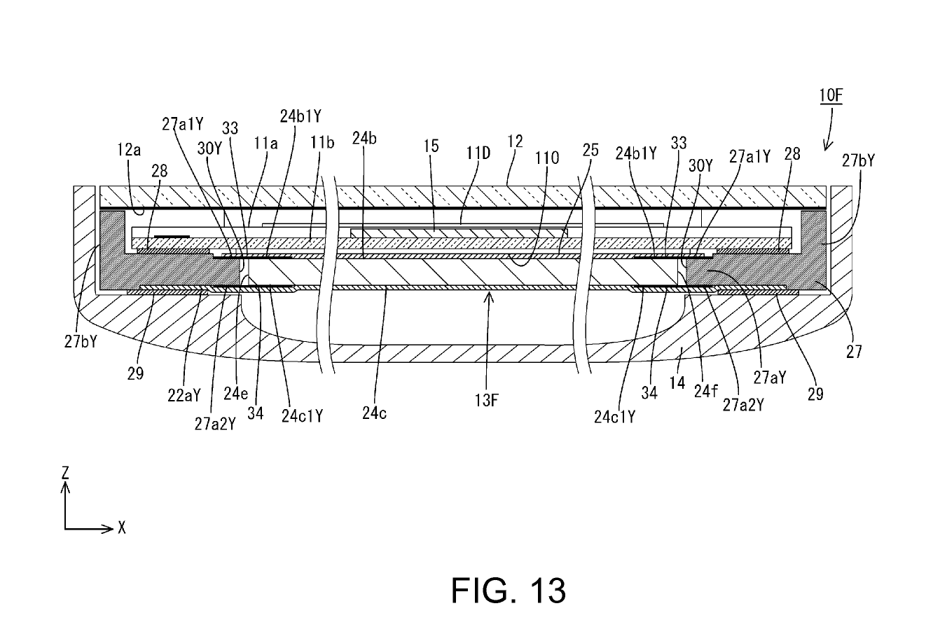

Next, Embodiment 7 of the present invention will be described while referring to FIG. 13. FIG. 13 is a cross-sectional view of a liquid crystal display device 10F according to Embodiment 7. FIG. 13 shows a cross-sectional view of a configuration cut along the shorter-side direction so as to pass through the vicinity of the driver 15 of a liquid crystal display device 10F. The present embodiment illustrates a liquid crystal display device 10F provided with a backlight device 13F. In the configuration of the liquid crystal display device 10F of the present embodiment, a third light absorbing member 33 and a fourth light absorbing member 34 have been further added to the liquid crystal display device 10 (backlight device 13) of Embodiment 1. The third light absorbing member 33 and the fourth light absorbing member 34 are for absorbing light and so forth that leaks out to the outer side from respective side faces (side faces) 24e and 24f of the longer-side sides of the light guide plate 24.

The third light absorbing member 33 is a member for absorbing light that has leaked out from the side faces 24e and 24f of the longer-side sides of the light guide plate 24, and is provided in the backlight device 13F so as to extend between a front side lateral peripheral edge 24b1Y adjacent to the side faces (side faces) 24e and 24f on the front surface (light-exiting surface) 24b of the light guide plate 24 and a front end 27a1Y of an inner wall (second wall) 27aY of the longer-side side. The third light absorbing member 33 includes a black-colored resin base material and so forth for absorbing light in the same manner as the first light absorbing member 31. The third light absorbing member 33 of the present embodiment is a small-thickness (thin) sheet, and an adhesive is applied to both surfaces (front and back surfaces) of an elastically deformable black-colored resin base material having either elasticity or flexibility. Therefore, both surfaces of the third light absorbing member 33 of the present embodiment function as adhesion surfaces that are capable of joining (adhering) to respective other members.

The third light absorbing member 33 of the present embodiment, in the plan view, forms an elongated rectangular shape extending along the shorter-side direction (Y-axis direction) of the light guide plate 24. A width (length) in the longer-side direction (Y-axis direction) of the third light absorbing member 33 is substantially the same as the length in the longer-side direction (Y-axis direction) of the light guide plate 24. One end in the shorter-side direction (X-axis direction) of the third light absorbing member 33 is bonded to the light-exiting surface 24b of the light guide plate 24 so that the back surface thereof adheres closely to a front side lateral peripheral edge 24b1Y. The other end 32b in the shorter-side direction (X-axis direction) of the third light absorbing member 33 is bonded to an inner wall (second wall) 27aY of the longer-side side so that the back surface thereof adheres closely to a front end 27a1Y. A front surface (front side) of the third light absorbing member 33 is bonded to the back surface of the optical sheet 25.

The fourth light absorbing member 34 is a member for absorbing at least light that leaks out to the outer side from a back side lateral peripheral edge 24c1Y adjacent to the side faces 24e and 24f on the rear surface 24c of the light guide plate 24. In addition thereto, in the case of the present embodiment, the fourth light absorbing member 34 is a member for absorbing light that has leaked out from the side faces 24e and 24f of the longer-side sides of the light guide plate 24. The fourth light absorbing member 34 is provided in the backlight device 13F so as to extend between the back side lateral peripheral edge 24c1Y and a back end 27a2Y of the inner wall (second wall) 27aY. The fourth light absorbing member 34 includes a black-colored resin base material and so forth for absorbing light in the same manner as the first light absorbing member 31 (third light absorbing member 33). The fourth light absorbing member 34 is a small-thickness (thin) sheet, and an adhesive is applied to both surfaces (front and back surfaces) of an elastically deformable black-colored resin base material having either elasticity or flexibility. Therefore, both surfaces of the fourth light absorbing member 34 of the present embodiment function as adhesion surfaces that are capable of joining (adhering) to respective other members.

The fourth light absorbing member 34 of the present embodiment, in the plan view, forms an elongated rectangular shape extending along the longer-side direction (Y-axis direction) of the light guide plate 24. A width (length) in the longer-side direction (Y-axis direction) of the fourth light absorbing member 34 is substantially the same as the length in the longer-side direction (Y-axis direction) of the light guide plate 24. That is, the fourth light absorbing member 34 is substantially the same external shape as the third light absorbing member 33. One end in the shorter-side direction (X-axis direction) of the fourth light absorbing member 34 is bonded to the rear surface 24c of the light guide plate 24 so that the front surface thereof adheres closely to (is furnished on) the back side lateral peripheral edge 24c1Y. The other end 32b in the shorter-side direction (X-axis direction) of the fourth light absorbing member 34 is bonded to the inner wall (second wall) 27aY of the longer-side side so that the front surface thereof adheres closely to the back end 27a2Y. The back surface of the fourth light absorbing member 34 is bonded to the front surface (front side) of the light reflective sheet 26.

Furthermore, a light absorbing surface 30Y is respectively disposed on the front surface of each inner wall (second wall) 27aY that faces the side faces (side faces) 24e and 24f of the light guide plate.

As described above, the backlight device 13F of the present embodiment has light absorbing surfaces 30Y and 30Y that face the side faces (side faces) 24e and 24f of the light guide plate 24 disposed between the light-receiving face 24a and the opposite surface 24d, and that absorb light that has leaked out from the light guide plate 24, and is provided with: a third light absorbing member 33 that extends between the inner wall (second wall) 27aY disposed along the front-back direction (thickness direction, Z-axis direction) of the light guide plate, front side lateral peripheral edges 24b1Y and 24b1Y adjacent to the side faces (side faces) 24e and 24f on the light-exiting surface 24b, and the front end 27a1Y of the inner wall (second wall) 27aY, and absorbs light that has leaked out from the light guide plate 24; and a fourth light absorbing member 34 that extends between back side lateral peripheral edges 24c1Y and 24c1Y adjacent to the side faces (side faces) 24e and 24f on the rear surface 24c and the back end 27a2Y of the inner wall (second wall) 27aY, and absorbs light that has leaked out from the light guide plate 24.

Light that leaks out to the outer side from the side faces (side faces) 24e and 24f of the light guide plate in accordance with the LED 22 or other such light source that is being used may cause uneven luminance the same as Embodiment 1 and so forth. In a case such as this, when the backlight device 13F constitutes the above-described configuration, light and so forth that leaks out to the outer side from the side faces (side faces) 24e and 24f of the light guide plate 24 is absorbed by the third light absorbing member 33 and the fourth light absorbing member 34, thereby suppressing light exiting from the light-exiting surface 24b from being biased to the side faces (side faces) 24e and 24f sides, which, in turn, further suppresses uneven luminance in the backlight device 13F.

### Reference Example 1

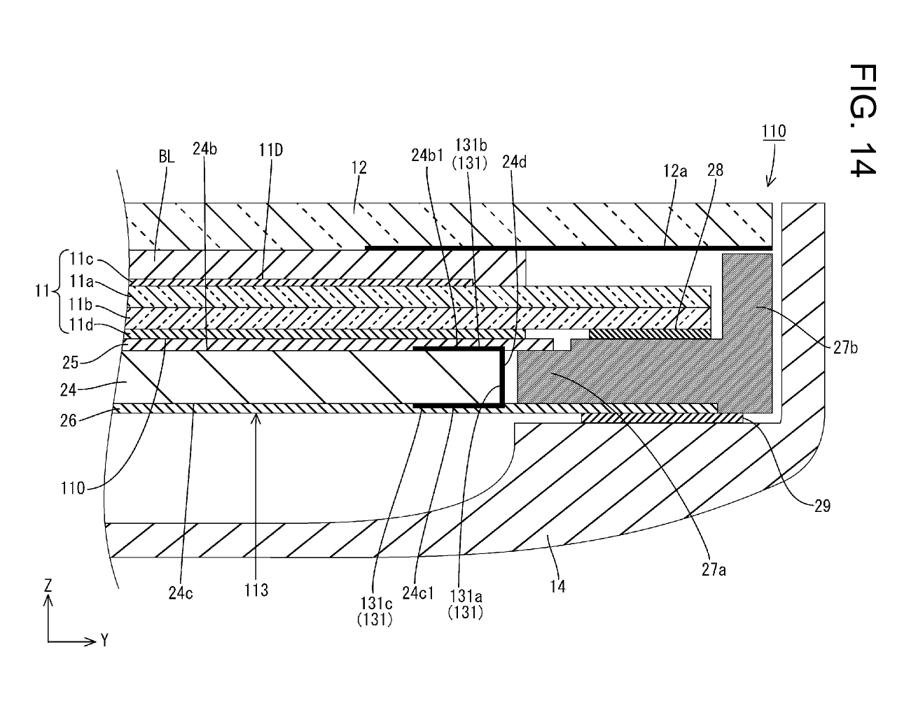

Reference Example 1 of the present invention will be described next by referring to FIG. 14. In the respective reference examples that follow, the same reference characters as Embodiment 1 are given to portions that are the same as Embodiment 1, and detailed descriptions (configurations, effects, and so forth) will be omitted. Reference Example 1 illustrates a liquid crystal display device 110 provided with a backlight device 113. The basic configuration of the liquid crystal display device 110 is the same as that of Embodiment 1. However, in the liquid crystal display device 110 of Reference Example 1, a fifth light absorbing member 131 formed from a light absorbing sheet (film) is used in place of the first light absorbing member 31 and the second light absorbing member 32.

The fifth light absorbing member 131 is formed from the same material as the light absorbing members 31 and 32 of Embodiment 1. The fifth light absorbing member 131 is bonded to the light guide plate 24 so as to cover at least the opposite surface 24d of the light guide plate 24, and to cover the front periphery 24b1. Of the light that has entered inside light guide plate 24 from the light-receiving face 24a, the fifth light absorbing member 131 of Reference Example 1 absorbs light that has reached the opposite surface 24d. The fifth light absorbing member 13 of Reference Example 1 is bonded to the light guide plate 24 so as to cover the rear periphery 24c1 as well.

The backlight device (illumination device) 113 of Reference Example 1 is provided with: an LED (light source) 22 (refer to Embodiment 1); a light guide plate 24, which that is a plate-shaped member having a light-receiving face 24a that is formed from one side face of the plate-shaped member and faces the LED (light source) 22, and on which light generated by the LED (light source) 22 is incident, an opposite surface 24d formed from one side face of the plate-shaped member that is on the side opposite to the light-receiving face 24a, and a light-exiting surface 24b that is formed from the front surface of the plate-shaped member and from which light that has entered from the light-receiving face exits; and a fifth light absorbing member 131 that is bonded to the light guide plate 24 so as to cover the opposite surface 24d, and extends from a front periphery 24b1 adjacent to the opposite surface 24d on the light-exiting surface 24b to a rear periphery 24c1 adjacent to the opposite surface 24d on a rear surface 24c of the light guide plate 24, which is on the opposite side to the light-exiting surface 24b.

In the backlight device (illumination device) 113 of Reference Example 1, light that has entered from the light-receiving face 24a of the light guide plate 24 advances through the inside of the light guide plate 24 and exits mainly from the light-exiting surface 24b before reaching the opposite surface 24d. Some of the light that has entered the light guide plate 24 from the light-receiving face 24a reaches the opposite surface 24d, and is absorbed by the portion 131a of the fifth light absorbing member 131 that covers the opposite surface 24d. Some of the light that has reached the opposite surface 24d is reflected by the opposite surface 24d, and thereafter goes toward the light-exiting surface 24b. Of this light, the light that goes toward the front periphery 24b1 of the light-exiting surface 24b is absorbed by the portion 131b of the fifth light absorbing member 131 that covers the front periphery 24b1. After being reflected by the opposite surface 24d, the light that goes toward the rear periphery 24c1 of the rear surface 24c is absorbed by the portion 131c of the fifth light absorbing member 131 that covers the rear periphery 24c1.

Therefore, in the backlight device (illumination device) 113 of Reference Example 1, of the light that has entered the light guide plate 24 from the light-receiving face 24a, the light that reached the opposite surface 24d is absorbed by the fifth light absorbing member 131, and thereby suppressed in a similar manner as Embodiment 1 from exiting from the light-exiting surface 24b. As a result of this, the concentration of light to the opposite surface 24d side of light exiting the light-exiting surface 24b is suppressed, and, in turn, uneven luminance in the backlight device (illumination device) 113 is suppressed.

### Reference Example 2

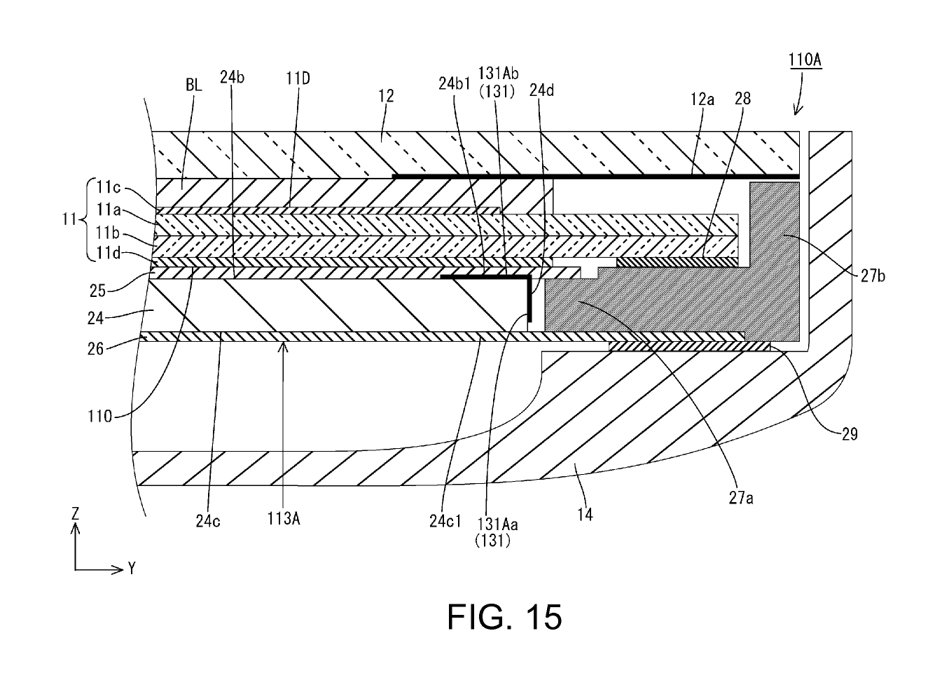

Reference Example 2 of the present invention will be described next while referring to FIG. 15. FIG. 15 is a partial cross-sectional view of a liquid crystal display device 110A according to Reference Example 2. Reference Example 2 illustrates the liquid crystal display device 110A provided with a backlight device 113A. The basic configuration of the liquid crystal display device 110A is the same as that of Reference Example 1. However, in the liquid crystal display device 110A of Reference Example 2, the fifth light absorbing member 131A is bonded so as to cover the opposite surface 24d and the front periphery 24b1.

In Reference Example 2, one portion 131Ab of the fifth light absorbing member 131A is bonded so as to cover the front periphery 24b1 of the light-exiting surface 24b of the light guide plate 24 and so that a portion 131Aa protrudes to the outer side from the opposite surface 24d. Then, the opposite surface 24d is covered by the remaining portion 131Aa that protrudes more to the outer side from the front periphery 24b1 than the opposite surface 24d. In Reference Example 2, the opposite surface 24d may be completely covered by the fifth light absorbing member 131A (131Aa).

The backlight device (illumination device) 113A of Reference Example 2 is provided with: an LED (light source) 22 (refer to Embodiment 1); a light guide plate 24 that is a plate-shaped member having a light-receiving face 24a that is formed from one side face of the plate-shaped member and faces the LED (light source) 22, and on which light generated by the LED (light source) 22 is incident, an opposite surface 24d formed from one side face of the plate-shaped member that is on a side opposite to the light-receiving face 24a, and a light-exiting surface 24b that is formed from the front surface of the plate-shaped member, and from which light that has entered from the light-receiving face exits; and a fifth light absorbing member 131A that is bonded to the light guide plate 24 so that a front periphery 24b1 adjacent to the opposite surface 24d on the light-exiting surface 24b is covered while covering the opposite surface 24d.

In the backlight device (illumination device) 113A of Reference Example 2, light that has entered from the light-receiving face 24a of the light guide plate 24 advances through the inside of the light guide plate 24 and exits mainly from the light-exiting surface 24b before reaching the opposite surface 24d. Some of the light that has entered the light guide plate 24 from the light-receiving face 24a reaches the opposite surface 24d, and is absorbed by a portion 131Aa of the fifth light absorbing member 131 that covers the opposite surface 24d. Some of the light that has reached the opposite surface 24d is reflected by the opposite surface 24d, and thereafter goes toward the light-exiting surface 24b. Of this light, the light that goes toward the front periphery 24b1 of the light-exiting surface 24b is absorbed by a portion 131Ab of the fifth light absorbing member 131 that covers the front periphery 24b1.

Therefore, in the backlight device (illumination device) 113A of Reference Example 2, of the light that has entered the light guide plate 24 from the light-receiving face 24a, the light that reached the opposite surface 24d is absorbed by the fifth light absorbing member 131A, and thereby suppressed in a similar manner as Embodiment 1 (Reference Example 1) from exiting from the light-exiting surface 24b. As a result of this, the concentration of light to the opposite surface 24d side of light exiting the light-exiting surface 24b is suppressed, and, in turn, uneven luminance in the backlight device (illumination device) 113A is suppressed.

### OTHER EMBODIMENTS

The present invention is not limited to the embodiments explained using the above descriptions and drawings, and embodiments such as the following, for example, are also included in the technical scope of the present invention.

(1) In Embodiment 1 and so forth above, an adhesive surface was formed on both sides of the first light absorbing member, but in another embodiment, an adhesive surface may be formed on only one side (either the front side or the back side).

(2) In Embodiment 1 and so forth above, an adhesive surface was formed on both sides of the second light absorbing member, but in another embodiment, an adhesive surface may be formed on only one side (either the front side or the back side).

(3) In Embodiment 1 and so forth above, a black-colored material was used in both the first light absorbing member and the second light absorbing member, but in another embodiment, a gray-colored material or the like via which the absorption coefficient is suppressed may be used as appropriate in accordance with the amount of light to be absorbed by the first light absorbing member and the second light absorbing member. The absorption coefficient of the first light absorbing member and the second light absorbing member is set to be higher than at least a light reflective member, such as a light reflective sheet.

(4) In Embodiment 7 above, the third light absorbing member and the fourth light absorbing member were used simultaneously, but in another embodiment, in addition to the first light absorbing member, only the third light absorbing member may be used, or only the fourth light absorbing member may be used.

(5) In Embodiment 7 above, an adhesive surface was formed on both sides of the third light absorbing member, but in another embodiment, an adhesive surface may be formed on only one side (either the front side or the back side).

(6) In Embodiment 7 above, an adhesive surface was formed on both sides of the fourth light absorbing member, but in another embodiment, an adhesive surface may be formed on only one side (either the front side or the back side).

(7) In Embodiment 7 above, a black-colored material was used in both the third light absorbing member and the fourth light absorbing member, but in another embodiment, a gray-colored material or the like via which the absorption coefficient is suppressed may be used as appropriate in accordance with the amount of light to be absorbed by the third light absorbing member and the fourth light absorbing member. The absorption coefficient of the third light absorbing member and the fourth light absorbing member is set to be higher than at least a light reflective member, such as a light reflective sheet.

(8) In Embodiment 7 above, the fourth light absorbing member extends between the back side lateral peripheral edge adjacent to the side face on the rear surface of the light guide plate and the back end of the second wall, but in another embodiment, the fourth light absorbing member may be used by being furnished only on the back side lateral peripheral edge in accordance with the amount of light to be absorbed.

(9) In an embodiment other than those described above, it is also possible to add a touch panel (positional information detection panel) between the cover panel and the liquid crystal panel, and in this case, it is preferred that the cover panel and the touch panel be bonded together using an adhesive, and that the touch panel and the liquid crystal panel be bonded together using an adhesive. In addition thereto, a touch panel pattern can be formed and touch panel functions (positional location information detection functions) can also be provided to the cover panel. A projection-type electrostatic capacitance technique, a surface-type electrostatic capacitance technique, a resistance film technique, or an electromagnetic inductance technique can be used as the touch panel pattern for the touch panel.

(10) In an embodiment other than those described above, it is also possible to add a parallax barrier panel between the cover panel and the liquid crystal panel, and in this case, it is preferred that the cover panel and the parallax barrier panel be bonded together using an adhesive, and that the parallax barrier panel and the liquid crystal panel be bonded together using an adhesive. The parallax barrier panel has a parallax barrier pattern for allowing an observer to observe an image displayed on the display screen of the liquid crystal panel as a stereoscopic image (3D image, three-dimensional image) via parallax separation. When using the liquid crystal panel as the parallax barrier panel, it is possible to switch between a planar image (2D image, two-dimensional image) and a stereoscopic image. It is also possible to form a parallax barrier pattern on the cover panel and to provide the cover panel with parallax barrier functions.

(11) In the embodiments described above, the cross-sectional shape of the panel support frame was shown as forming a three-tiered step shape, but the number of tiers in the cross-sectional shape of the panel support frame can be changed as needed.

(12) In the embodiments described above, a case in which the backlight device and the liquid crystal panel are mounted using a panel adhesive tape was described, but the backlight device and the liquid crystal panel may be affixed in a mounted condition using a technique other than adhesive tape (fastened by screws or rivets, for example).

(13) In the embodiments described above, the panel support frame is shown as having been formed in a frame shape, but it is also possible to use a configuration that makes the panel support frame an approximate box shape, which is open on the front side, and supports the light guide plate and the reflective sheet from the back side using the bottom part thereof. In this case, it is possible to use a configuration in which the LED substrate is supported from the back side by the bottom part of the panel support frame.

(14) In the embodiments described above, the present invention was illustrated as having three colored parts, i.e. R, G, B, as the color filters of the liquid crystal panel, but the colored parts can be four or more colors.

(15) In the embodiments described above, the present invention was described as using LEDs as the light source, but another light source, such as a cold cathode fluorescent tube, can also be used.

(16) In the embodiments described above, a case in which tempered glass that had been subjected to a chemical strengthening process was used as the cover panel was described, but it goes without saying that tempered glass that has been subjected to an air-blast quenching strengthening process (thermal strengthening process) can also be used.

(17) In the embodiments described above, a liquid crystal display device of the type having a display screen that is longer than it is wide was illustrated, but a liquid crystal display device of the type having a display screen that is wider than it is long is also included in the present invention. Furthermore, a liquid crystal display device having a square display screen is also included in the present invention.

(18) In the embodiments described above, TFTs were used as the switching elements in the liquid crystal display device, but a liquid crystal display device that uses switching elements other than TFTs (thin film diodes (TFD), for example) are also applicable, and in addition to a liquid crystal display device that displays in color, a liquid crystal display device that displays in black and white is also applicable.

### DESCRIPTION OF REFERENCE CHARACTERS

10, 10A, 10B, 10C, 10D, 10E, 10F liquid crystal display device (display device)
11 liquid crystal panel (display panel)
11a CF substrate
11b array substrate
11D display surface
11O opposite surface
12 cover panel
12a light-shielding part
13, 13A, 13B, 13C, 13D, 13E, 13F backlight device (illumination device)
14 casing (case member)
16 TFT (switching element)
18 gate wire
19 source wire
22 LED (light source)
24 light guide plate
24a light-receiving face
24b light-exiting surface
24b1 front periphery
24c rear surface
24c1 rear periphery
24d opposite surface
24e, 24f side face
25 optical sheet (downward-facing lens sheet)
26 light reflective sheet (light reflective member)
27 panel support frame
27a inner wall (first wall)
27a1 front end
27a2 back end
27aY inner wall on longer-side side (second wall)
28 panel adhesive tape
29 casing adhesive tape
30, 30D light absorbing surface
31 first light absorbing member
32 second light absorbing member
33 third light absorbing member
34 fourth light absorbing member
AA display area
BB adhesive
NAA non-display area

1. An illumination device, comprising:
a light source;
a light guide plate that is a plate-shaped member having a light-receiving face formed on one side face thereof that opposes said light source so as to receive light therefrom, an opposite face opposite to said light-receiving face, and a light-exiting surface on a front side from which light that has entered from the light-receiving face exits;
a first wall having a light absorbing surface facing said opposite face to absorb light that has leaked from the light guide plate, said first wall being disposed along a front-back direction of said light guide plate; and
a first light absorbing member that extends from a front periphery of the light guide plate in the light-exiting surface adjacent to the opposite face, and that reaches a front end of said first wall so as to absorb light that has leaked from the light guide plate.

2. The illumination device according to claim 1, further comprising:
a second light absorbing member disposed on a rear periphery of the light guide plate in a rear surface adjacent to the opposite face so as to absorb light that has leaked from the light guide plate.

3. The illumination device according to claim 2, wherein said second light absorbing member extends from said rear periphery of the light guide plate and reaches a rear end of the first light absorbing member.

4. The illumination device according to claim 1, wherein said first light absorbing member has a sheet-like shape and an adhesive surface on either one side or both sides thereof.

5. The illumination device according to claim 4, wherein said first light absorbing member is bonded via said adhesive surface to the front periphery of the light guide plate and the front end of the first wall.

6. The illumination device according to claim 5, wherein said first light absorbing member is either expandable and contractible or bendable.

7. The illumination device according to claim 2, wherein said second light absorbing member has a sheet-like shape and an adhesive surface on either one side or both sides thereof.

8. The illumination device according to claim 7, wherein said second light absorbing member is bonded via said adhesive surface to the rear periphery of the light guide plate and a rear end of the first wall.

9. The illumination device according to claim 8, wherein said second light absorbing member is either expandable and contractible or bendable.

10. The illumination device according to claim 2, further comprising:
a light reflective sheet having light reflecting characteristics disposed on a rear surface of the light guide plate such that an end of the light reflective sheet protrudes beyond the opposite face of the light guide plate,
wherein the second light absorbing member is a coated film having light absorption characteristics formed on said light reflective sheet.

11. The illumination device according to claim 1, wherein the first wall is formed from a light absorbing material, and the light absorbing surface of the first wall is a surface of the first wall facing the opposite face of the light guide plate.

12. The illumination device according to claim 1, wherein the light absorbing surface of the first wall is a front surface of a light absorbing layer that is bonded so as to cover an opposing surface of the first wall facing the opposite face of the light guide plate, said light absorbing layer absorbing light.

13. The illumination device according to claim 1, further comprising:
a second wall having a light absorbing surface that faces another side face of said light guide plate to absorb light that has leaked from said light guide plate, said second wall being disposed along the front-back direction of said light guide plate;
a third light absorbing member that extends from a front lateral periphery of the light guide plate in the light-exiting surface adjacent to said another side face, and that reaches a front end of said second wall so as to absorb light that has leaked from said light guide plate; and
a fourth light absorbing member that extends from a rear lateral periphery of the light guide plate in the rear surface adjacent to said another side face, and that reaches a rear end of said second wall so as to absorb that has leaked from said light guide plate.

14. The illumination device according to claim 2, wherein said second light absorbing member is a coated film having light absorption characteristics formed on the rear periphery of the light guide plate.

15. A display device, comprising:
the illumination device according to claim 1; and
a display panel that displays an image using light from said illumination device.
